(19) United States
(12) Patent Application Publication
(10) Pub. No.: US 2008/0168156 A1
(43) Pub. Date: Jul. 10, 2008

(54) Event liaison system

(76) Inventors: Chris Haff, Watertown, MA (US); Darren Ross, Manchester, MA (US); Colin Henson, Jamaica Plain, MA (US); Jonell Gades, Bellingham, MA (US)

Correspondence Address: LAMBERT & ASSOCIATES, P.L.L.C., 92 STATE STREET, BOSTON, MA, 02109-2004, US

(21) Appl. No.: 11/651,345

(22) Filed: Jan. 9, 2007

(51) Int. Cl. G06F 15/167

(52) U.S. Cl. 709/219

(57) ABSTRACT

The event liaison system of the present invention comprises portable event liaison devices as part of an overall system that may communicate via wireless and wired protocols. The system organizes and manages events, providing communication of upcoming events, speaker information, meeting materials, and post event access to information via a personalized microsite. The system enables user interaction and participation for providing the most interactive and efficiently run overall event.

### BACKGROUND OF THE INVENTION

1. Field of the Invention

This invention relates generally to the field of event management systems, and more particularly to systems for coordinating and providing attendee participation and interaction for managed events.

2. Description of the Related Art

As the current fast paced world continues to become more and more efficient, businessmen and woman are often purchasing the latest technology designed to accomplish a multitude of tasks. These devices allow the user to be able to work efficiently on the go, by combining the ability to email, make phone calls, and organize their schedules. Business men and woman often spend a significant amount of their time attending business meetings. However, in order to not disrupt the flow of the meetings or presentations, the audience is typically required to hold their questions, comments or concerns until the end of the meeting. Even the most astute of listeners are often faced with situations in which they are not in pace with the presenter, this may be as a result of attempting to write notes or questions, trying to understand previous presentation slides, or simply being unable to maintain attention. There are a number of devices currently on the market that allow the audience to actively participate in presentations or meetings, and others that allows users to interact with video presentations.

One such device, produced by Machine Dreams®, is portable and is comprised of an alphanumeric keypad, a microphone, and a display screen (i.e. LCD). This device allows the user to interact with a presenter's questions by entering numbers and letters using the keypad. The data is then wirelessly transmitted, compiled, and then presented graphically to provide the presenter feedback. The device also incorporates a microphone enabling audio recording, which enables the user to participate in discussions.

Another such device named eponymous, produced by Spotlight Mobile® is portable and provides for audio and video playback while the user is conducting a facility tour. The device is able to recognize its location within the facility and to record a user's actions with the device, such as which features were viewed and for how long. The data within the device can be automatically and continually updated using a wireless communication system. User data can then be compiled and extracted for analysis.

Another such device, produced by nTAG, Inc. combines interactive name badges that communicate bi-directionally with other name badges (via infrared) and with a central server (via 802.15 wireless protocol). The solution includes software applications, database management, and reporting via a web browser, accessible by meeting organizers and attendees. Using the name badge device allows users to find other users, view an agenda, participate in polls and surveys and receive messages. The name badge device is based on proprietary, custom designed hardware.

Another such device named SpotMe and created by Shockfish SA provides a portable device is based on proprietary, custom designed hardware. The device consists of a black and white screen and five input buttons. Using this device users can find other users, view an agenda, participate in polls and surveys, exchange virtual business cards with photos and receive messages. Shockfish also provides services for reporting and user registration.

While these prior art solutions may be acceptable for their intended use, none of them provide a consistent, effective means to apply the most efficient application for participants of events that may comprise a number of presentations.

Therefore, what is required is a system that organizes and communicates a variety of event information, including presentations, speakers and the materials used in the presentation.

What is also required is a portable device that can be preloaded with meeting materials, and then assigned to unique event attendees.

What is further required is a device that is capable of becoming part of a wireless network, whereby information is later stored and retrievable by the attendee.

Additionally, it is required to provide a device that is quickly and easily comprehended, and provides a description of all events and scheduled presentations.

What is also required is a system that can notify users of incoming messages during scheduled events.

It is also required to provide users with polling questions that may be then tabulated and results made available in near real-time.

### BRIEF SUMMARY OF THE INVENTION

Therefore, it is an object of the present invention to provide an event organizing system that organizes and communicates a variety of event information, including presentations, speakers and the materials used in the presentation.

Another object of the present invention is to provide a system that includes portable devices that allow for user interaction and enhanced interest in live presentations.

It is also an object of the present invention to provide an event management system that provides users with the ability to retrieve event information long after the event has concluded.

### BRIEF DESCRIPTION OF THE SEVERAL VIEWS OF THE DRAWINGS

These and other features, aspects and advantages of the present invention will become better understood with reference to the following description, appended claims, and accompanying drawings where:

FIG. 1 details an embodiment of the system communication method.

FIG. 2 details an embodiment of the system's overall site map showing embodiments of the various user interactive pages displayed on the primary page of the device.

FIG. 3 details an embodiment of the initial Getting Started/Welcome page to the user.

FIG. 3A details an embodiment of an alternative initial welcome page to the user.

FIG. 4 details an embodiment of the method of registering an individual user to a specific device.

FIG. 4A details an embodiment of the method of registering a group member user.

FIG. 5 details an embodiment of the Confirm User page.

FIG. 6 details an embodiment of the method of returning a registered device to the Administrator of the system.

FIG. 7 details an embodiment of the Return Handheld page.

FIG. 7A details an embodiment of the return handheld Confirmation page.

FIG. 8 details an embodiment of the method of using the device for the user.

FIG. 9 details an embodiment of the right or left-handed selection page.

FIG. 10 details an embodiment of the Getting Started/Welcome page.

FIG. 11 details an embodiment of the device in the right-handed view/perspective.

FIG. 12 details an embodiment of the device in the left-handed view/perspective.

FIG. 13 details an embodiment of the primary navigation bar.

FIG. 14 details an embodiment of an Agenda page.

FIG. 15 details an embodiment of an Agenda Items page which appears once the user clicks on a specific agenda item.

FIG. 16 details of an embodiment of the Home Page.

FIG. 17 details an embodiment of the polling process.

FIG. 18 details an embodiment of a pop-up page visible to users when the Administrator activates various polls on the system.

FIG. 19 details an embodiment of the Poll Results Page when no results have been tallied yet.

FIG. 20 details an embodiment of the Poll Results Page with a category selector and a listing of available poll result categories.

FIG. 21 details an embodiment of the poll result category listing page.

FIG. 22 details an embodiment of the poll result display page.

FIG. 23 details an embodiment of the Speakers page speaker listing.

FIG. 24 details an embodiment of the Speaker detail page.

FIG. 25 details an embodiment of the Inbox page.

FIG. 26 details an embodiment of the message detail page.

FIG. 27 details an embodiment of the regular new message pop up page.

FIG. 28 details an embodiment of the priority new message pop up page.

FIG. 29 details an embodiment of the Meeting Materials page.

FIG. 30 details an embodiment of the subcategory meeting materials listing page.

FIG. 31 details an embodiment of the Concierge page with a category selector.

FIG. 32 details an embodiment of the concierge category listing page.

FIG. 33 details an embodiment of the concierge detail page.

FIG. 34 details an embodiment of the ask a question page.

FIG. 35 details an embodiment of the ask a question thank you page.

FIG. 36 details an embodiment of the user Settings page.

FIG. 37 details an embodiment of the presentation application.

FIG. 38 details the site map of the microsite

FIG. 39 details an embodiment of the microsite home webpage

FIG. 40 details an embodiment of the microsite agenda webpage

FIG. 41 details an embodiment of the microsite agenda webpage with details revealed

FIG. 42 details an embodiment of the microsite poll results group overview webpage

FIG. 43 details an embodiment of the microsite poll results group detail webpage with a poll result item revealed.

FIG. 44 details an embodiment of the microsite meeting materials overview webpage with groups l-n expanded and group n board member sub-group expanded.

FIG. 45 details an embodiment of the microsite candids video webpage

FIG. 46 details an embodiment of the microsite change password webpage

FIG. 47 details an embodiment of the administration site agenda overview webpage

FIG. 48 details an embodiment of the administration site agenda item detail webpage

FIG. 49 details an embodiment of the administration site add/edit agenda item webpage

FIG. 50 details an embodiment of the administration site announcements listing webpage

FIG. 51 details an embodiment of the administration site add/edit announcement webpage

FIG. 52 details an embodiment of the administration site add announcement select location and recipient webpage

FIG. 53 details an embodiment of the administration site event venue listing webpage

FIG. 54 details an embodiment of the administration site event venue listing webpage with details expanded

FIG. 55 details an embodiment of the administration site add/edit event venue webpage

FIG. 56 details an embodiment of the administration site location listing webpage

FIG. 57 details an embodiment of the administration site add/edit location webpage

FIG. 58 details an embodiment of the administration site meeting materials listing webpage

FIG. 59 details an embodiment of the administration site add/edit materials listing webpage

FIG. 60 details an embodiment of the administration site poll listing webpage

FIG. 61 details an embodiment of the administration site add/edit poll webpage

FIG. 62 details an embodiment of the administration site location to user assignments webpage

FIG. 63 details an embodiment of the administration site add/edit user webpage

FIG. 64 details an embodiment of the administration site first device to user assignment webpage

FIG. 65 details an embodiment of the administration site final device to user selection webpage

FIG. 66 details an embodiment of the administration site device return webpage

### DETAILED DESCRIPTION OF THE INVENTION

The subject application discloses an event management system. In this system event planners can access a website over the Internet containing an agenda management microsite. This microsite allows the event planners to enter information on an upcoming event by entering data into various categories of their choosing, including location and venue information, reservation information, meeting agenda, schedule and descriptions of presentations, meeting materials, details of speakers and any other information which the planner deems relevant to the event. The event planner may designate specific event attendees to invite to the event or provide for a general invitation to selected groups. The microsite may be designed to send electronic invitations out for the event. These invitations direct invitees to access a designated portion of the microsite over the Internet that gives them limited access based on payment for the event and/or special invitation.

At the beginning of the event, Administrators of the system download the entered microsite information into small handheld devices such as PDAs, IPAQ® handheld devices or other handheld devices (event liaison device). These devices are registered and distributed to event attendees (users) at the event. This system also embodies methods of conducting real time local and global polls using the devices. This system further embodies methods of allowing registered users to access the microsite over the Internet after the event which contains all the information entered by the Administrators including poll results, and any further materials added after the event.

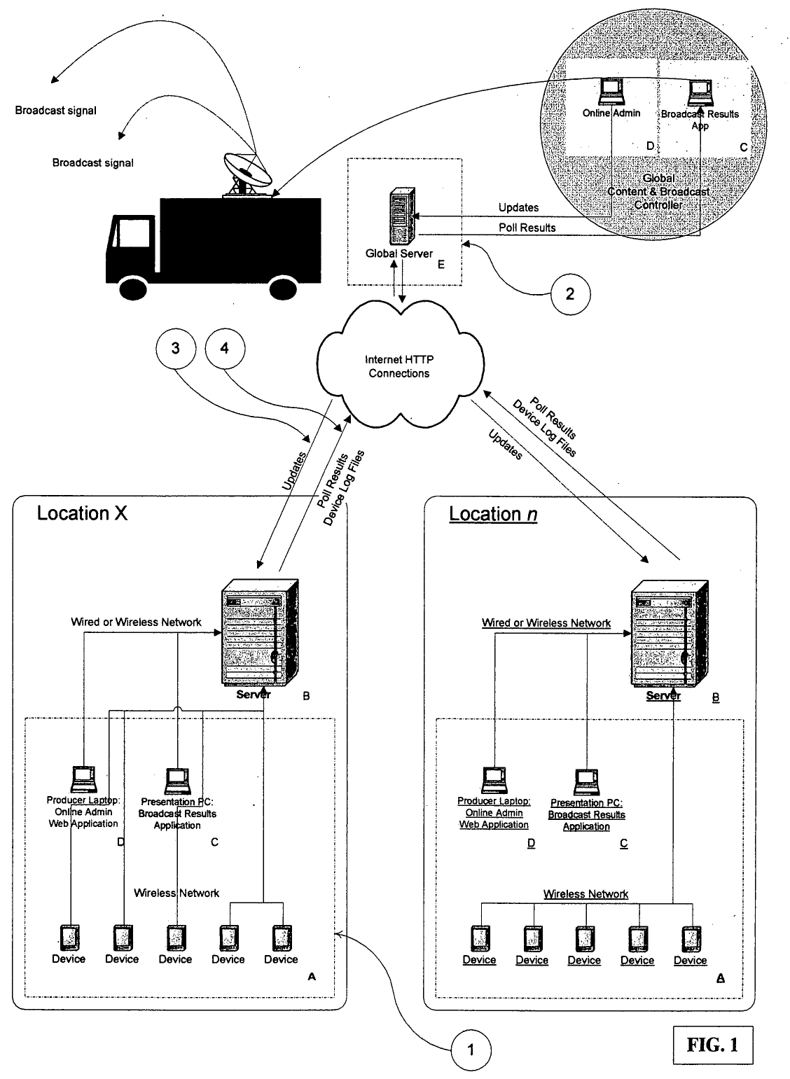

FIG. 1 details an embodiment of the network communications methods of the system at an event simultaneously conducted at separate locations (shown as “Location X” and “Location n”). Each of these locations can by itself be a self-contained event without further connections. The operation of a single location versus multi-location events is the same with the exceptions noted. Each location consists of one or more user devices A, local servers B, event presenter computers C and Administrator computers D. The user devices A, the event presenter computers C and the Administrator computers D are connected to a local server B by a wired and/or wireless network (1). Wireless networks may be conventional centralized networks using access points such as 801.11abg or peer to peer networks.

The local server B hosts a number of applications to support the system including, but not limited to a database server to store all data and content, a web application server that hosts the administration tools as well as Administrator web access, synchronization application for globally synchronized events, web services that are consumed by the devices A to access the event data, report usage, poll answers, poll results, messages, ask a question replies and other updates.

A presenter computer C used to present results to an audience via projection or television broadcast connects to local server B using the same web services that the Administrators use. For events with more than one location a data control application is used on the local servers B and on an additional global server E. The global server E is typically located in a remote data center location (2) and accessed over the Internet using HTTP protocol to avoid firewall issues from the remote data center location (2). The global server E and the local servers B run a synchronization application that is self configuring as the Local servers B register themselves with the global server E. Local servers B can synchronize themselves with the global server E to receive content updates (3) (agenda, polls, messages, etc.) which in turn can be distributed to the devices A at each location. Local servers B send user generated data (4) such as poll answers, questions and usage to the global server E. The global server E tallies data and returns aggregate results to the local server B which in turn relays information to the users through the devices A.

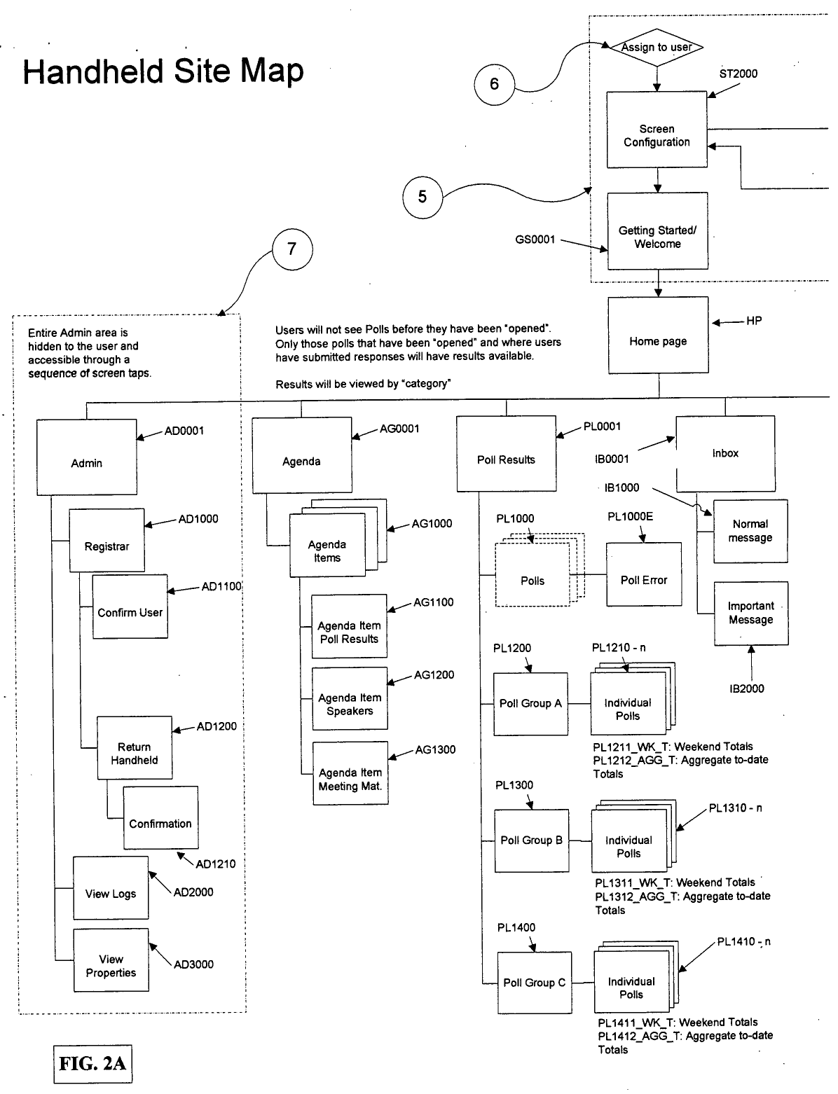

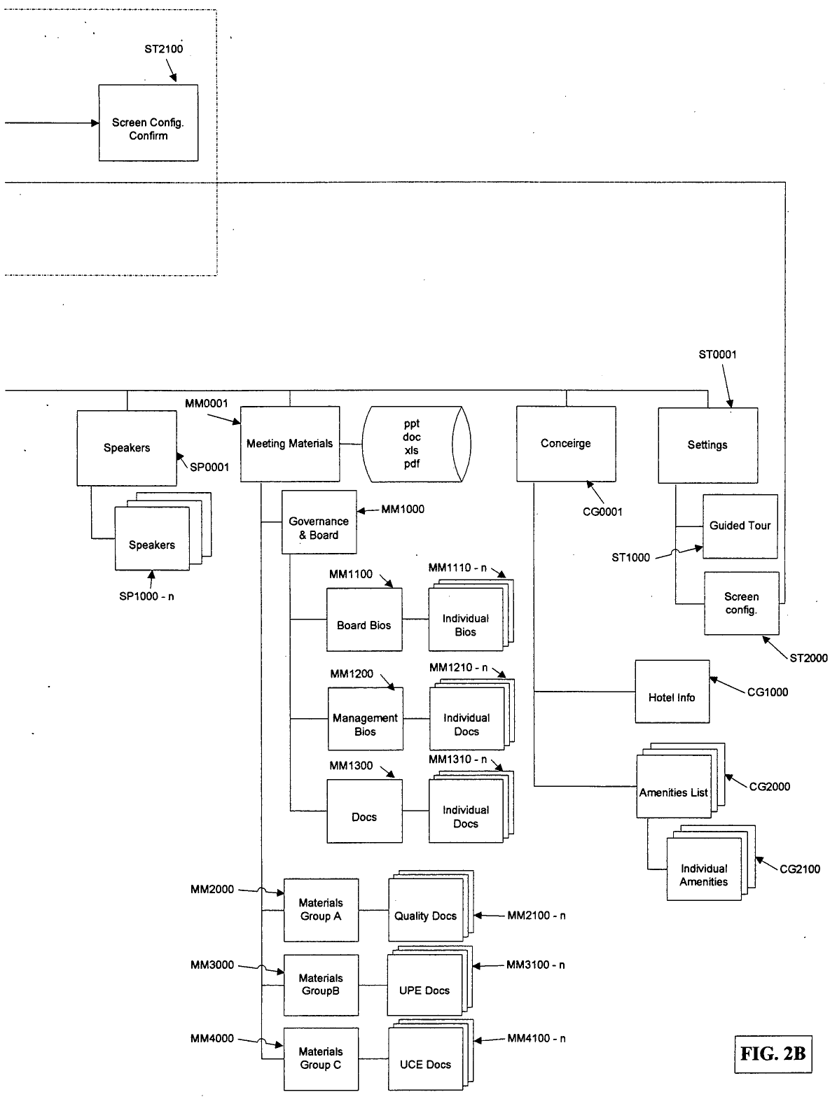

FIG. 2 details a preferred embodiment of the system's overall site map showing the various user interactive pages displayed on the primary screen of the devices A of FIG. 1. In this embodiment, the site map contains a few preliminary pages (5) such as an Assign to User page (6), a Screen configuration page (ST2000), a Getting Started/Welcome page (GS0001), and a home page (HP). This embodiment of the site map further displays various category pages (7) containing interactive functions available to the Administrator and the User of the system. These category pages include an Admin page (AD0001), an Agenda page (AG0001), a Poll Results page, (PL0001), an Inbox page, (IB0001), a Meeting Materials page (MM0001), a Concierge page (CG0001) and a Settings page (ST0001). The site map of FIG. 2 also displays subcategory pages accessed through the category pages. These subcategory pages are described in further detail below.

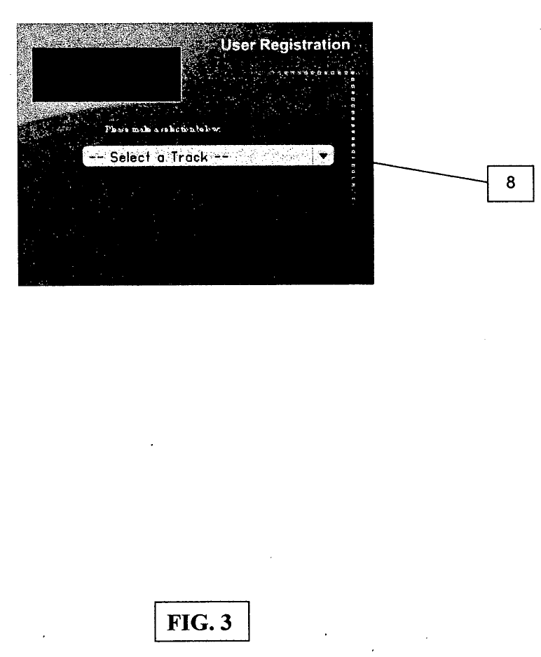

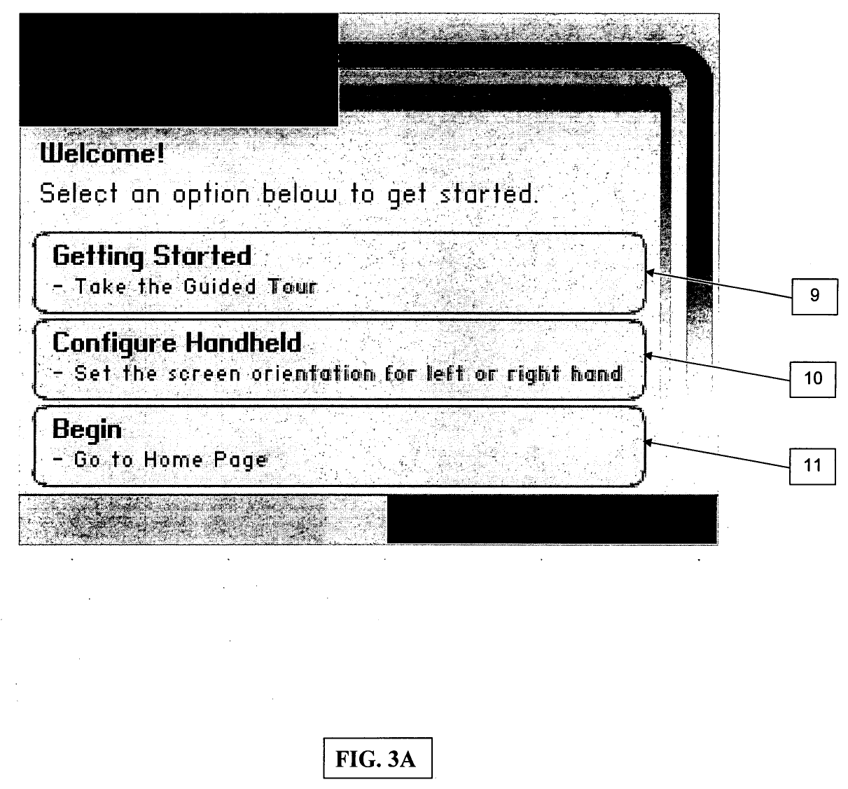

FIGS. 3 and 3A detail alternative embodiments of the initial Getting Started/Welcome page (GS0001) on the user devices. These embodiments allow the user to confirm his/her name, or group (8). In alternative embodiments, the group (8) may also be labeled track, region or division. FIG. 3A shows an embodiment of the Welcome Page (GS0001) which contains user interface button (9) linked to the Guided tour page (ST1000), button (10) linked to the Screen configuration page (ST2000) and button (11) linked to the Home Page (HP).

The first category page of FIG. 2, the Admin page (AD0001), is always hidden to the user and accessible only to an Administrator of the system. The site map of FIG. 2 lists several subcategory pages (7) accessed through the Admin page (AD0001) including a Registrar page (AD1000) that enables Administrators to further access a Confirm User page (AD1100) that confirms the user registered to the device and leads to a first Confirmation page (AD1110). The Registrar page (AD1000) also enables Administrators to access a Return Handheld page (AD1200) that confirms the return receipt of the registered device and leads to a second Confirmation page (AD1210). The Admin page (AD0001) further allows access to a View Logs page (AD2000) that displays information logged on the device and a View Properties page (AD3000) that displays the properties of the device.

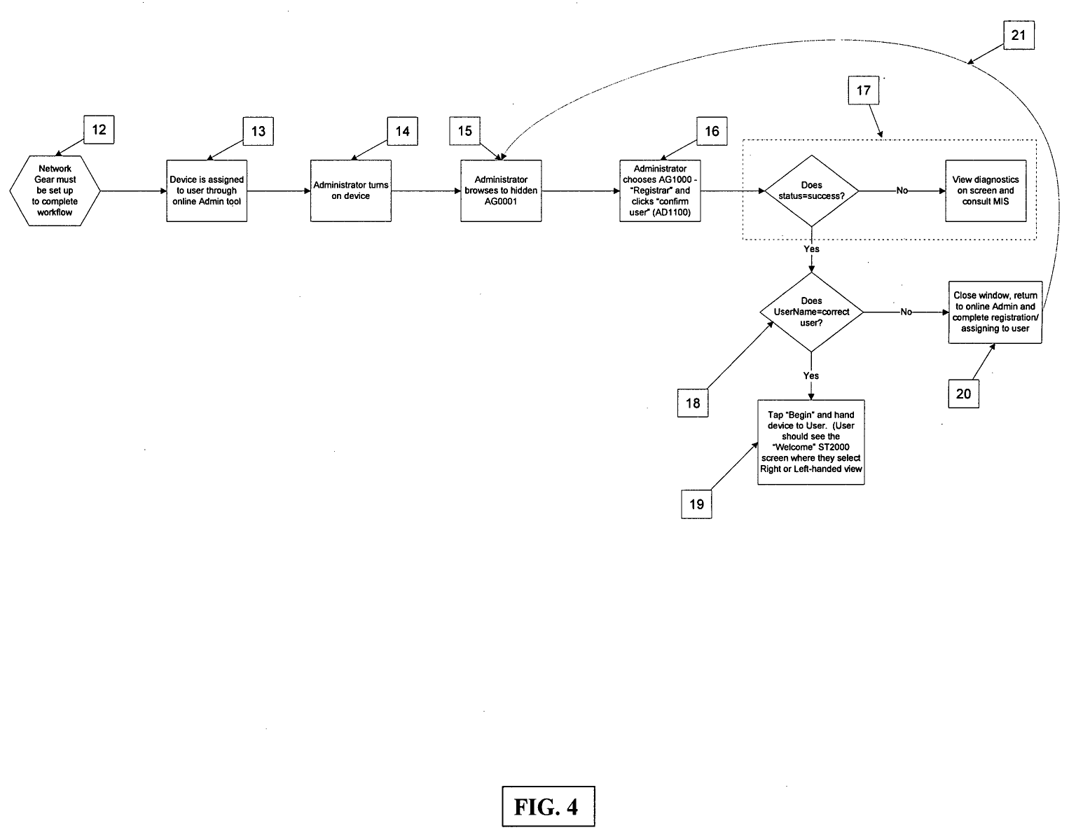

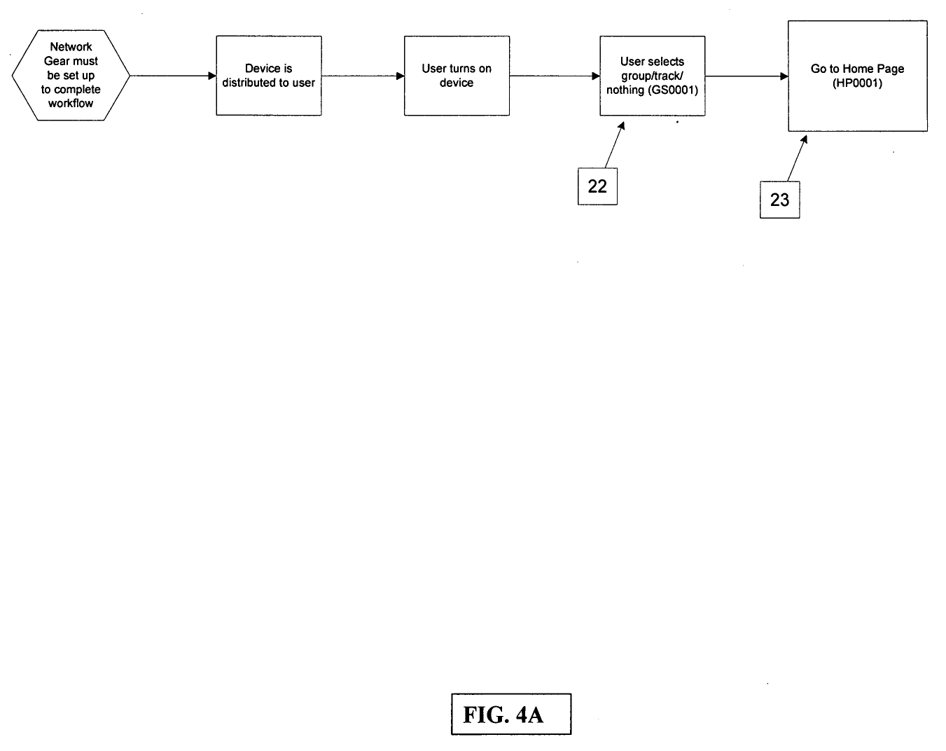

FIG. 4 details an embodiment of the method of registering a user to an individual device. In the first step (12), the associated network must be properly configured and setup. In the second step (13), the Administrator assigns a device to a user through an online administrator tool on the Administrator computer D displayed in FIG. 1. In the third step (14), the Administrator powers the device. In the fourth step (15), the Administrator browses the Admin page (AD0001) on the device A to locate the Registrar page (AD1000). In the fifth step (16), the Administrator accesses the Registrar page (AD1000) which enables the Administrator to confirm that the device is assigned to the correct user on the Confirm User page (AD1100). In the sixth step (17), the Administrator uses the Registrar page (AD1000) to confirm that the device is detecting the system network illustrated in FIG. 1. In the seventh step (18), the Administrator confirms the user, and if successful, the system will prompt the Administrator to the eighth step (19), to verify that the user name is correct. If the confirmation of the user is not successful, the Administrator will proceed to the ninth step (20) and view the diagnostics on the page. close the window, and repeat the registration process (21) beginning with the fourth step (15).

FIG. 4A details the method of registering a device for a user that is assigned to a group, or in alternative embodiments to a track, team, division or region. Once the groupings have been defined the user completes the first step (22) by selecting the group they belong to from the page depicted in FIG. 3. The user then completes the second step (23) by proceeding to the home page.

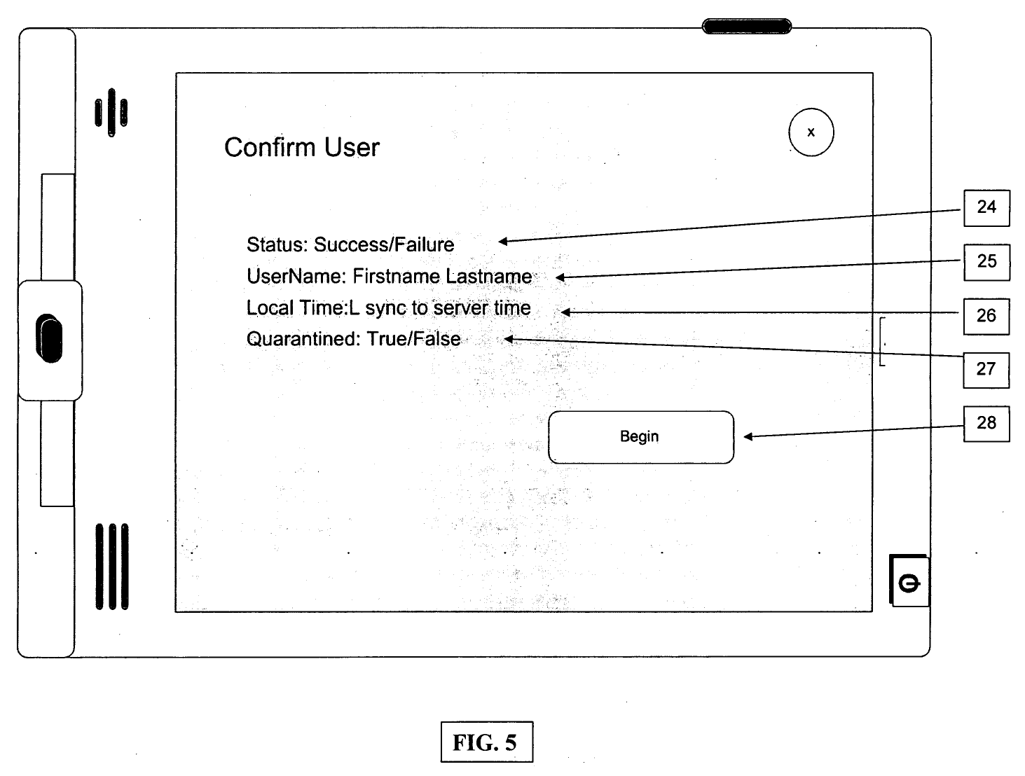

FIG. 5 details an embodiment of the Confirm User page. This embodiment displays the confirmation status (24), the username (25), the local time provided by the server (26), and the quarantine status (27). The page also displays a selectable “begin” button (28) to begin using the handheld device.

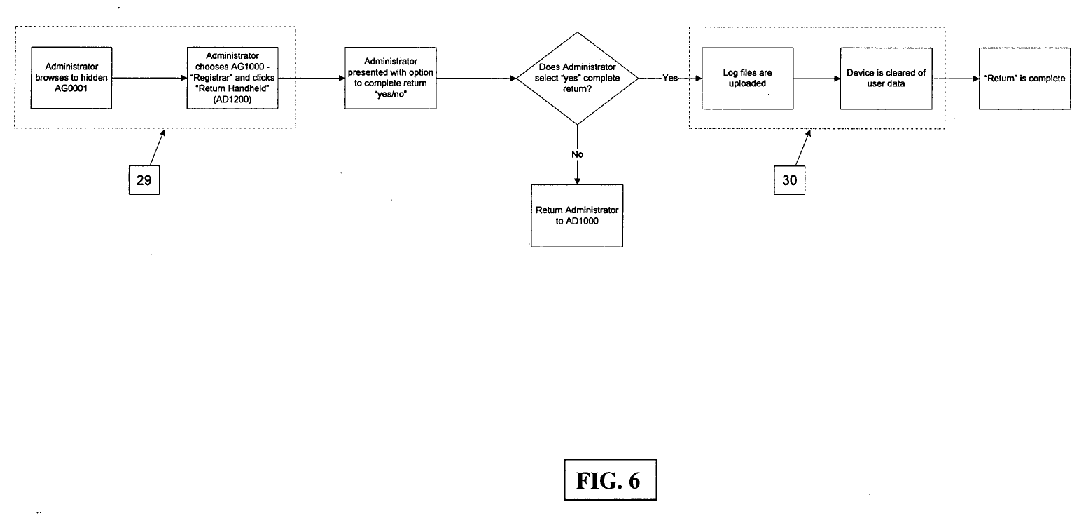

FIG. 6 details an embodiment of a method of a user returning a registered device. At the end of the meeting, or if, for some reason, a user has to turn in the device, the Administrator in the first step (29) will access the Return Handheld page (AD1200) from the Admin page (AD0001) to begin the “return” workflow (30). The primary purpose of the “return” workflow (30) is to upload activity logs and clear any user data from the device. The Administrator initiates the return of handheld which uploads the user tracking log to the network and clears the device of user data.

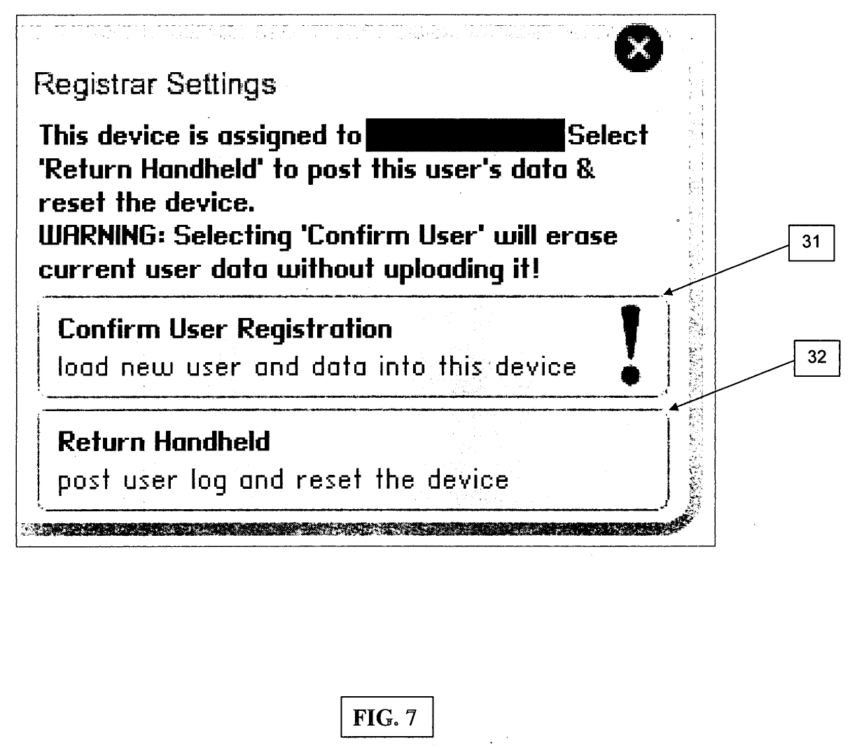

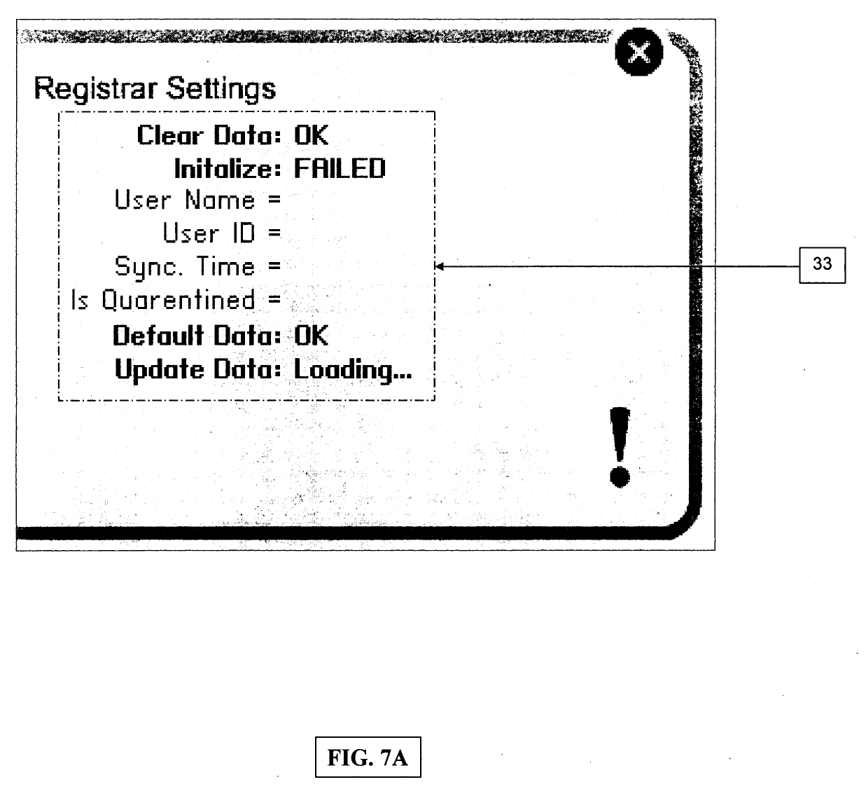

FIG. 7 details an embodiment of the Return Handheld page (AD1200). Clicking on the “Confirm User Registration” button (31) will result in a connection to the local server B that will look up the device ID and return the user information and a first update. FIG. 7A displays an embodiment of a Confirmation page (AD1210) which displays the status (33) of these transactions. Clicking on the “Return Handheld” button (32) results in all user tracking logs being transmitted to the local server B and the event log and user information being subsequently removed. The status is displayed on the Return Handheld page (AD1200).

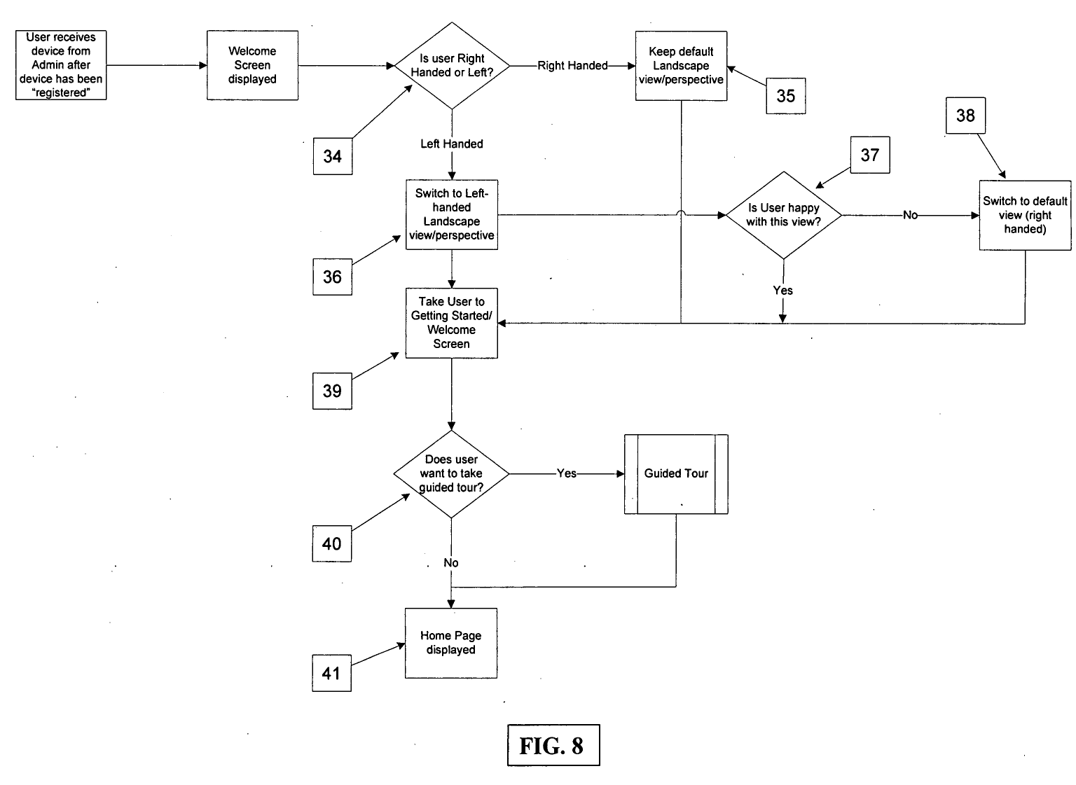

Once the device is confirmed registered, the user may begin using the device. The devices may be configured with means to allow a user to input data into the device. Such means include, but are not limited to touch sensitive screens, mini keyboards or other configurations of buttons known in the art. FIG. 8 outlines an embodiment of the method of using the device.

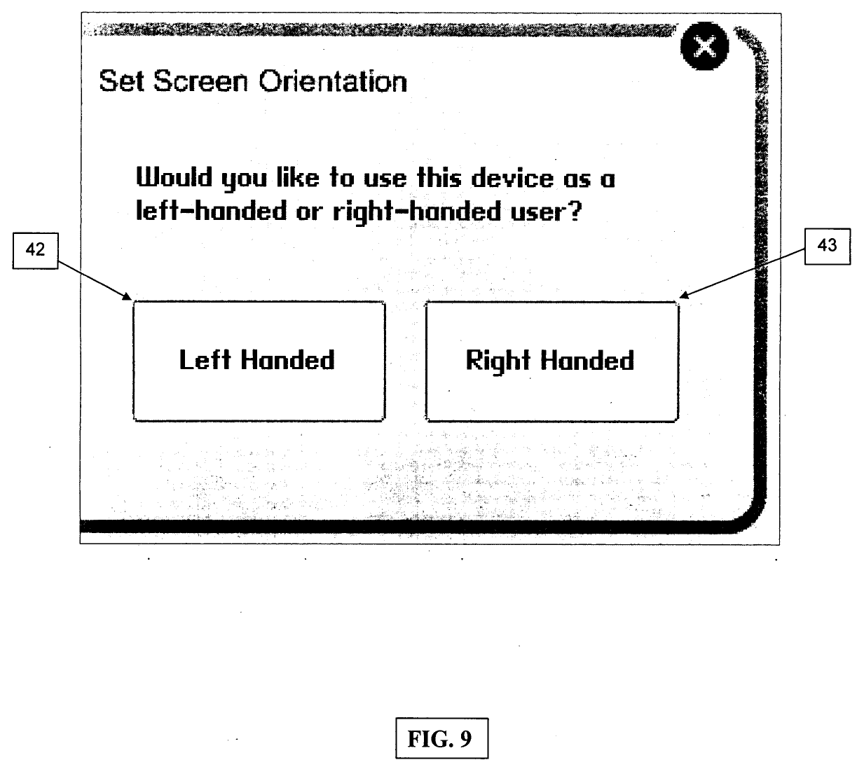

FIG. 8 details an embodiment of a method for the user initial welcome sequence that occurs after the registration page. Beginning the sequence is a splash screen that may optionally allow users to change the screen orientation (34) (as shown in FIG. 9). The default screen orientation is for right-handed users. Assuming the application is in its default state, selecting right-handed leaves the display unchanged (35); selecting left-handed will cause the display to rotate 180% and some of the device buttons for scrolling to be re-assigned (36). The user is then presented with a confirmation screen (37). If the user answers in the affirmative the display state is maintained. If they answer in the negative the display is restored to the previous view (38). After the confirmation screen this user is returned to the splash screen (39).

On the splash screen the user may further be presented with an optional guided tour button (40). A guided tour may consist of a digital video or an animated tour of the user interface of the handheld application or both. After the guided tour the user is returned to the splash screen.

If only one of the three options has been selected for a deployment the splash screen may be omitted. User will be presented with the screens for the one chosen option directly. If no options have been selected for a deployment the user is brought directly to the home page (HP) (41).

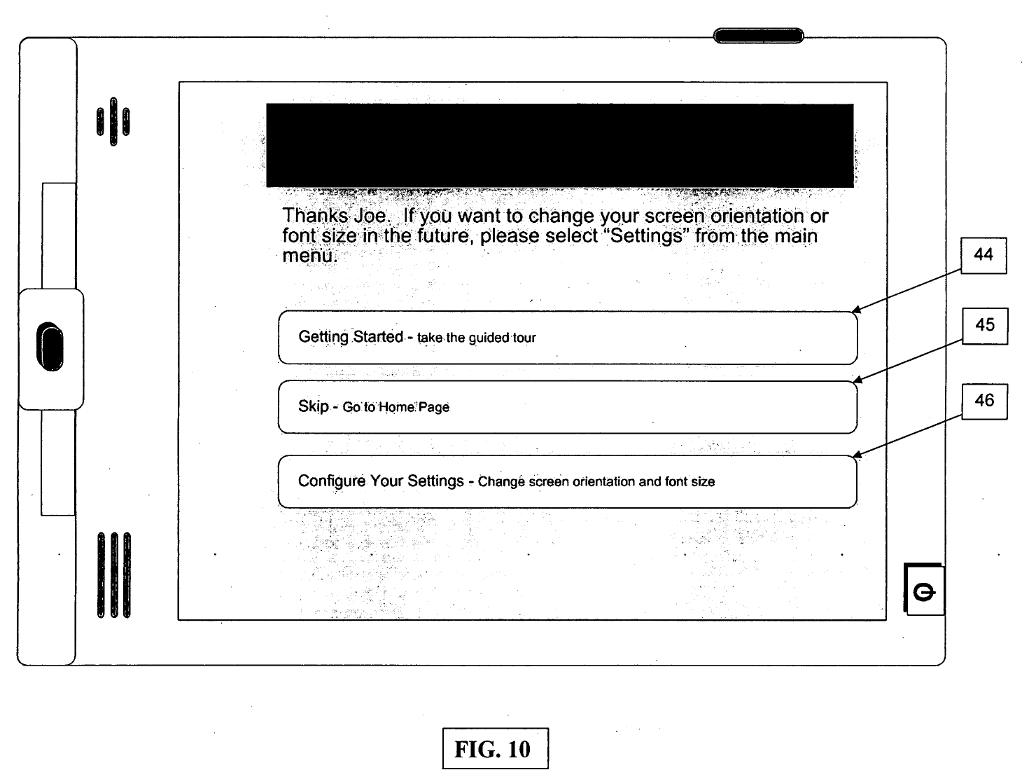

When the user first views the device, he or she will be prompted to define how they want to use the device, an embodiment of which is shown in FIG. 9. This embodiment displays a question of whether the user would like to use the device as a left or a right handed user. Users will have the option to change the right or left handed orientation at a later point. The user may then select between a right or left handed use by activating a right-handed user button (42) or a left-handed user button (43). FIG. 11 details an embodiment of the device in the right-handed view/perspective. FIG. 12 details an embodiment of the device in the left-handed view/perspective. If the user selects right handed use, the device is kept in its default landscape view/perspective. If the user selects left handed use, the device switches to the left handed landscape view/perspective. In one embodiment, the device will then guide the user to a Getting started/Welcome page (GS0001) as shown in FIG. 10. In an alternative embodiment, the user is brought to the home page (HP).

FIG. 10 details an embodiment of the Getting started/Welcome page (GS0001). This embodiment allows the user to select between viewing a guided tour of the handheld device by activating the Getting Started button (44) linked to Guided tour page (ST1000), skip the guided tour and go directly to the Home Page (HP) by activating the Skip button (45) linked to the Home Page, or configure the user settings, such as the screen orientation and font size by activating the Configure button (46) linked to the Screen configuration page (ST2000).

As noted above, once the user has returned to the Home Page (HP), he or she has access to one or more various category pages containing interactive functions. FIG. 2 illustrates one embodiment of the category pages available to the user including: Agenda page (AG0001), Poll Result page (PL0001), Inbox page (IB0001), Speakers page (SPO001), Meeting Materials page (MM0001), Concierge page (CG0001) and Settings page (ST 0001). In additional embodiments of the subject invention the user may access all or some of these category pages. In further embodiments of the subject invention, the user may be allowed access to certain category pages at a designated time of the event. In even further embodiments of the subject invention, fewer or additional category pages may be incorporated into the system.

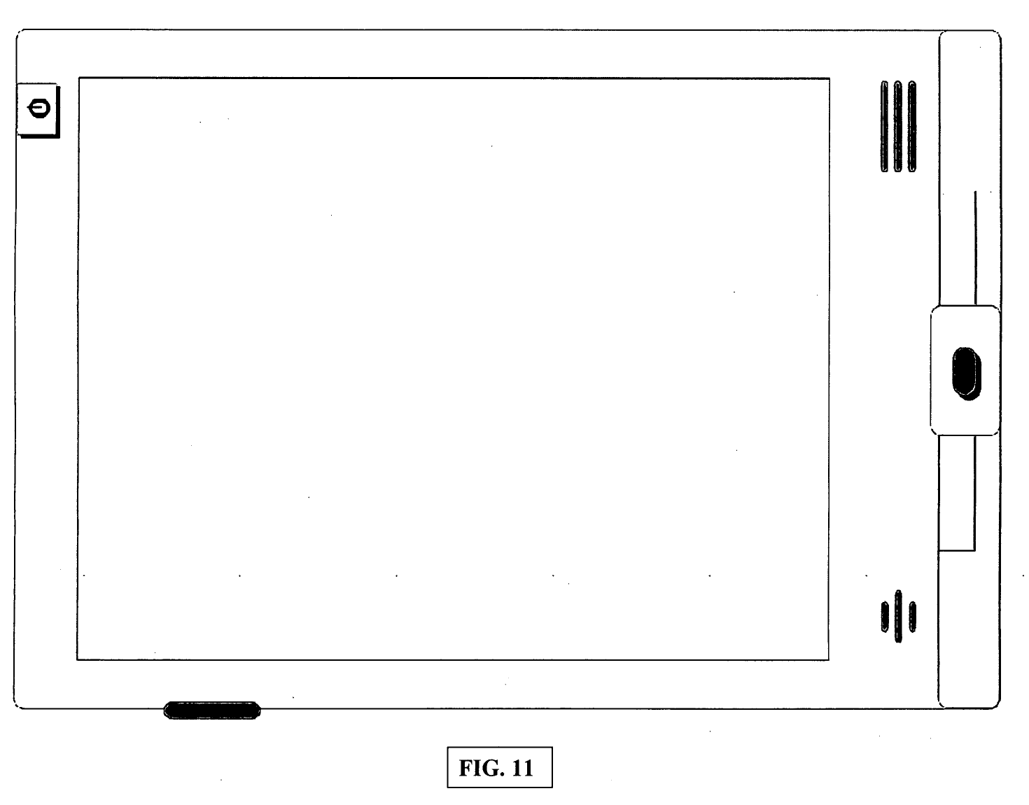

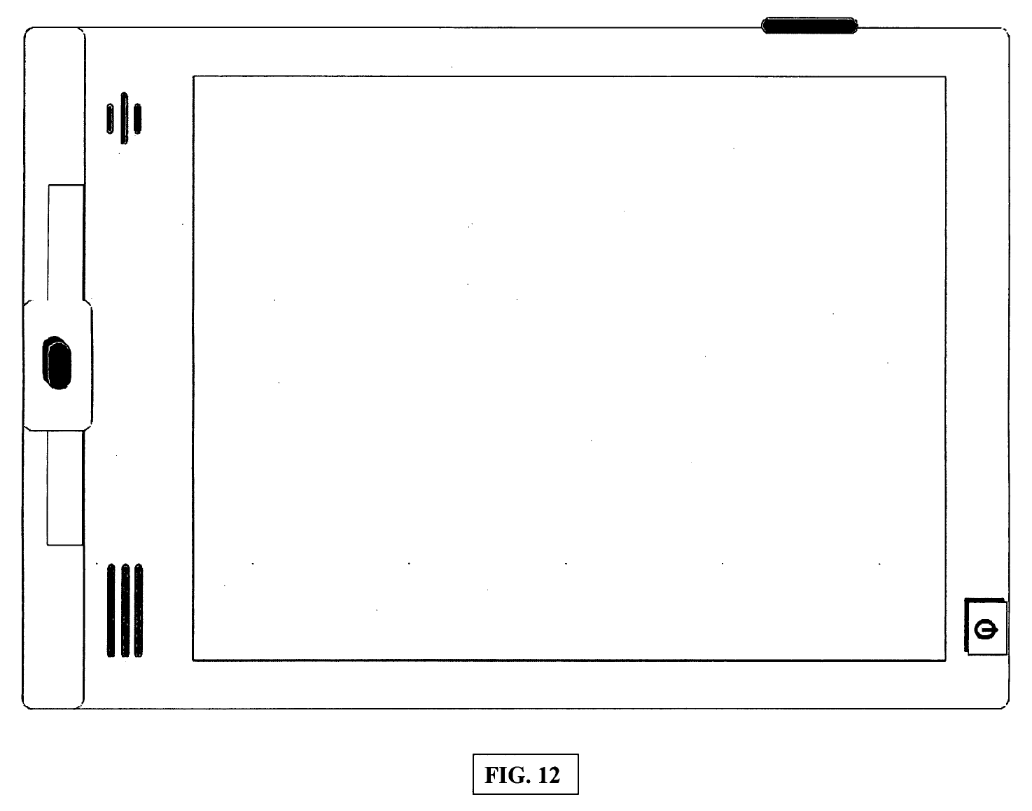

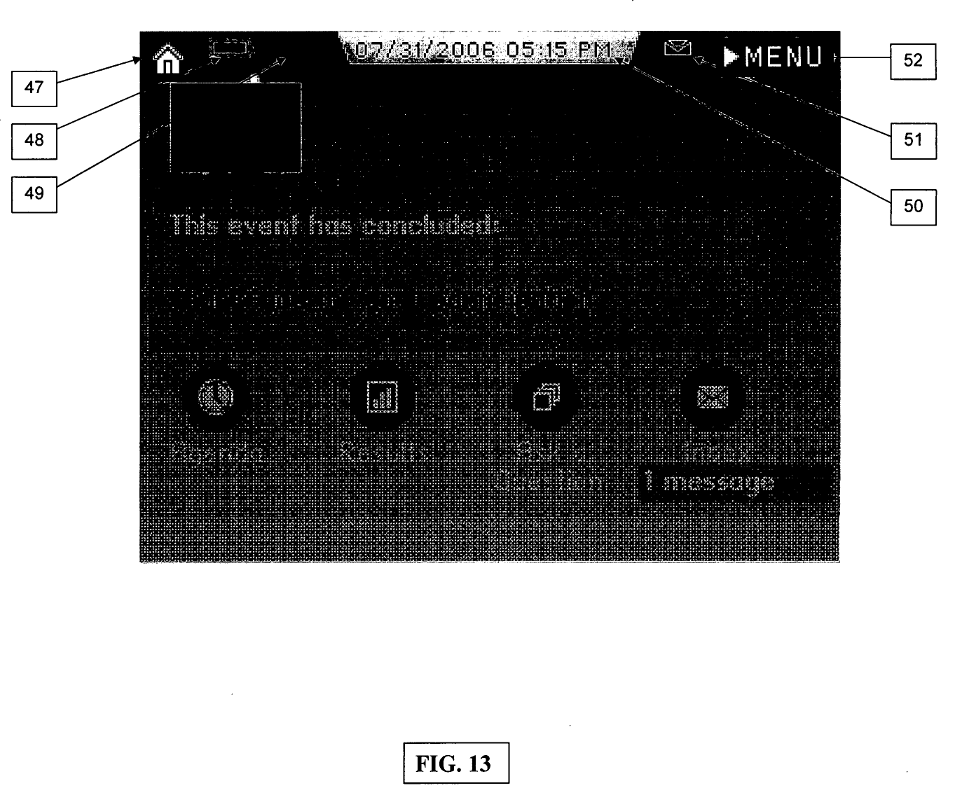

FIG. 13 details an embodiment of the primary navigation bar. This bar includes a link to the Home Page (HP) (47), an indication of the battery life of the device (48), an indication of Wifi/Bluetooth® signal strength (49), a display of the current date and time (50), an indication of unopened mail in the inbox (51), and a configurable drop-down menu (52). The configurable drop-down menu typically contains links to all modules available from the home page with the addition of settings and other less frequently used modules.

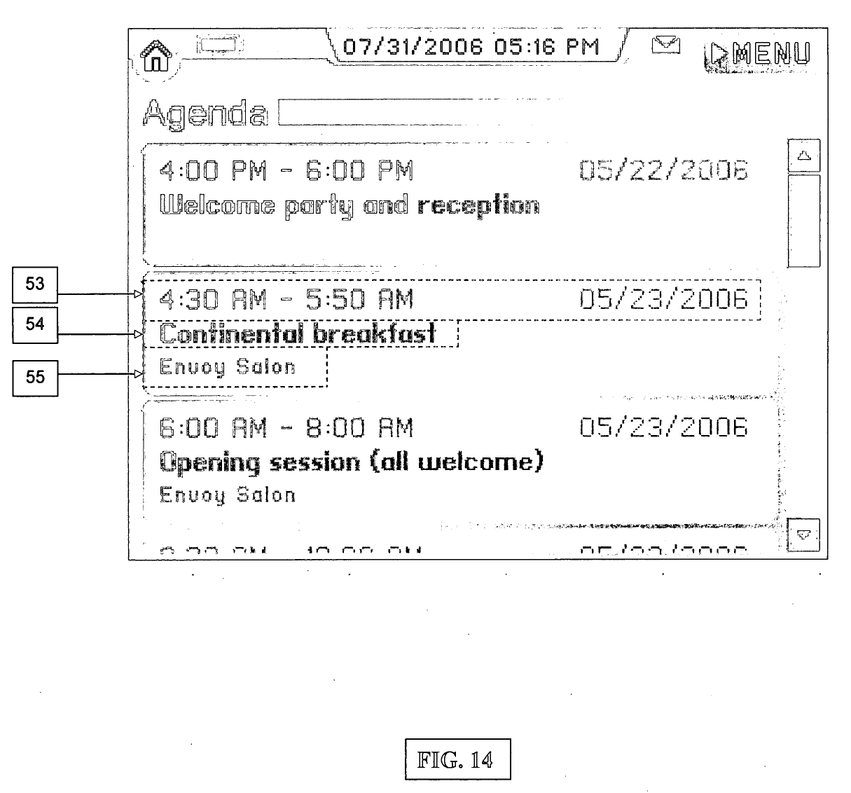

FIG. 14 details an embodiment of the Agenda page (AG0001). The times and dates (53), description (54) of each agenda item are listed, as well as the title and location (55) of each agenda item.

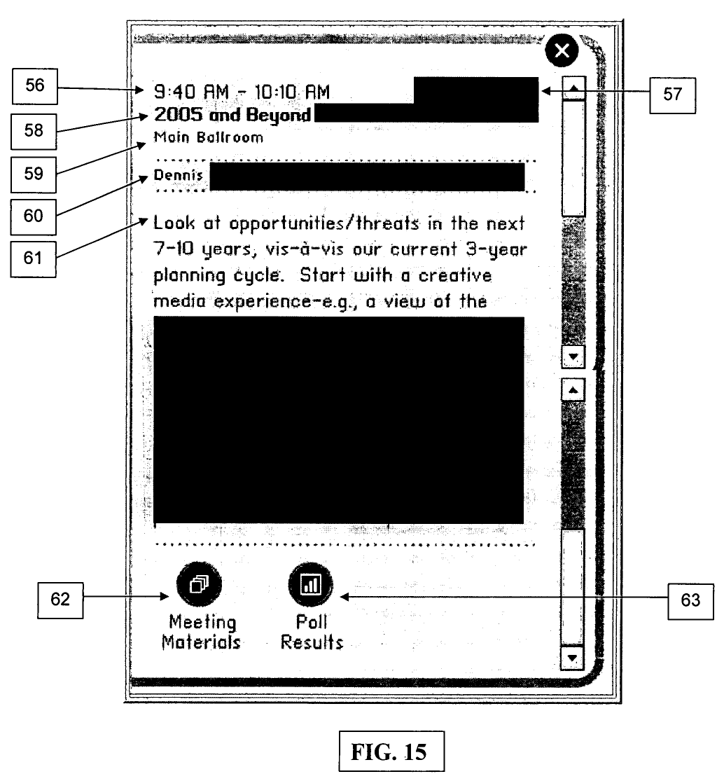

FIG. 15 details an embodiment of the Agenda Items page (AG1000) accessed once the user clicks on a specific agenda item on the Agenda page (AG0001). The time (56), date (57), title (58), location (59), speakers (60) and details (61) for the agenda item are listed. The Agenda Items page (AG1000) contains further links to an Agenda Item Poll Results page (63) (AG1100) which displays poll results for the agenda item, an Agenda Item Speakers page (AG1200) which displays the speaker details for the agenda item, and an Agenda Item Meeting Materials page (AG1300) which displays meeting materials for the agenda item. In additional embodiments of the subject invention, optional agenda items may include icons (62) which are links to an Agenda Item Meeting Materials page (AG1300), an Agenda Item Polls page (not shown) and an Agenda Item Quizzes page (also not shown.)

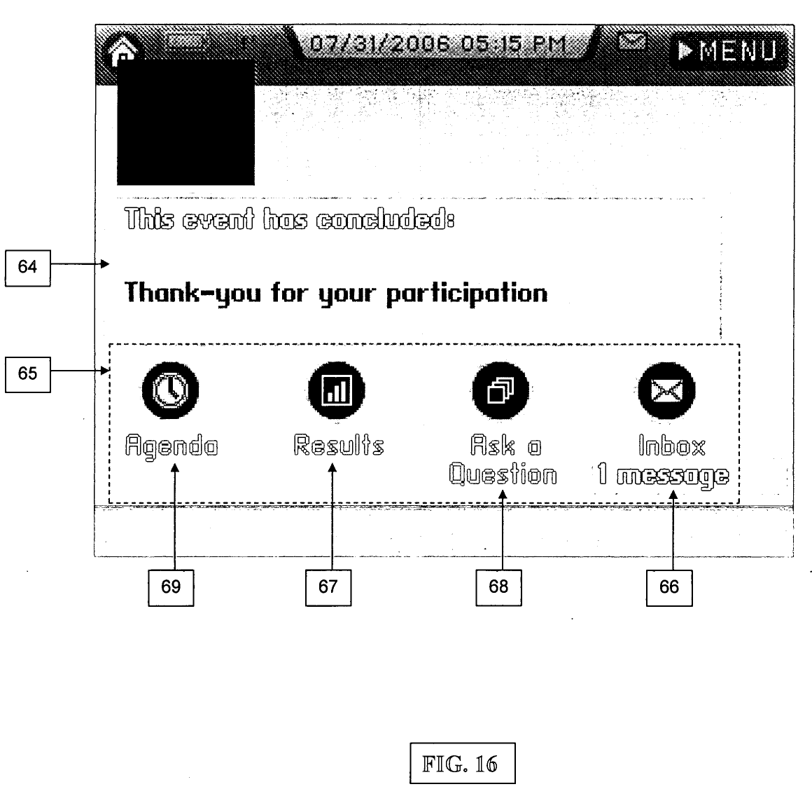

FIG. 16 details an embodiment of the Main Menu or Home Page (HP) that displays the current agenda item in the same format as agenda items in the Agenda page (AG0001) (Date, time, location, title). In this embodiment the first agenda item appears when the first event has not yet started. Once an event commences this page displays the currently ongoing event. Once the next event begins within a configurable number of minutes (e.g. 15 minutes), this next event will be displayed on the Home Page as the next item and the start time will be shown. The Home Page also indicates when an event has concluded as shown (64). Additional embodiments of the subject invention may contain further navigational elements as configurable buttons (65) including a button (66) linked to the Inbox page (IB0001), a poll results button (67) linked to the Poll Results page (PL0001), an Ask A Question button (68) linked to the Ask a Question Page, and an agenda button (69) linked to the Agenda Items page (AG1000).

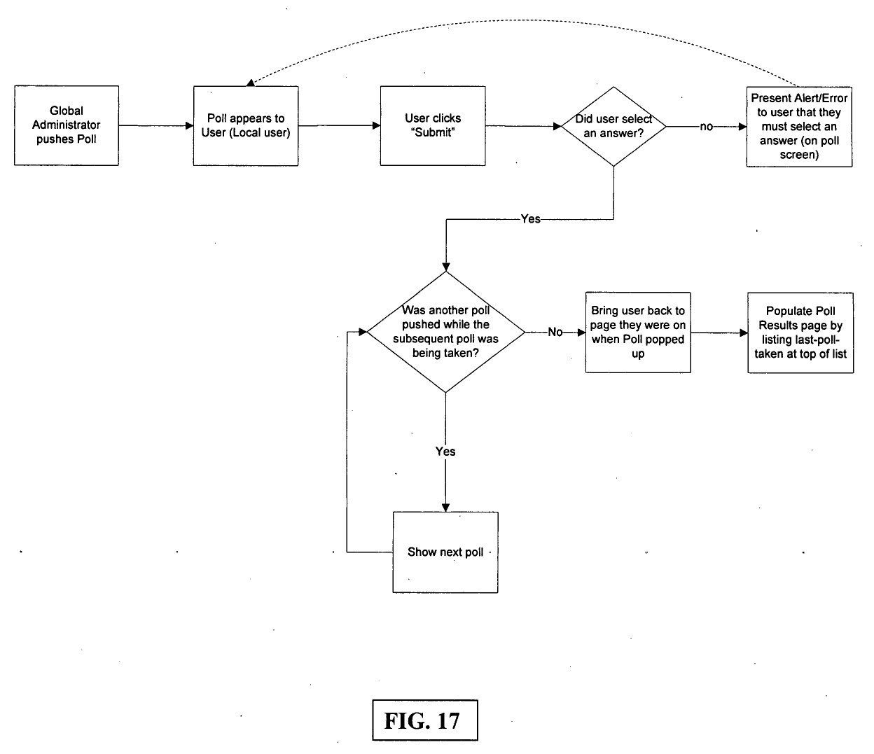

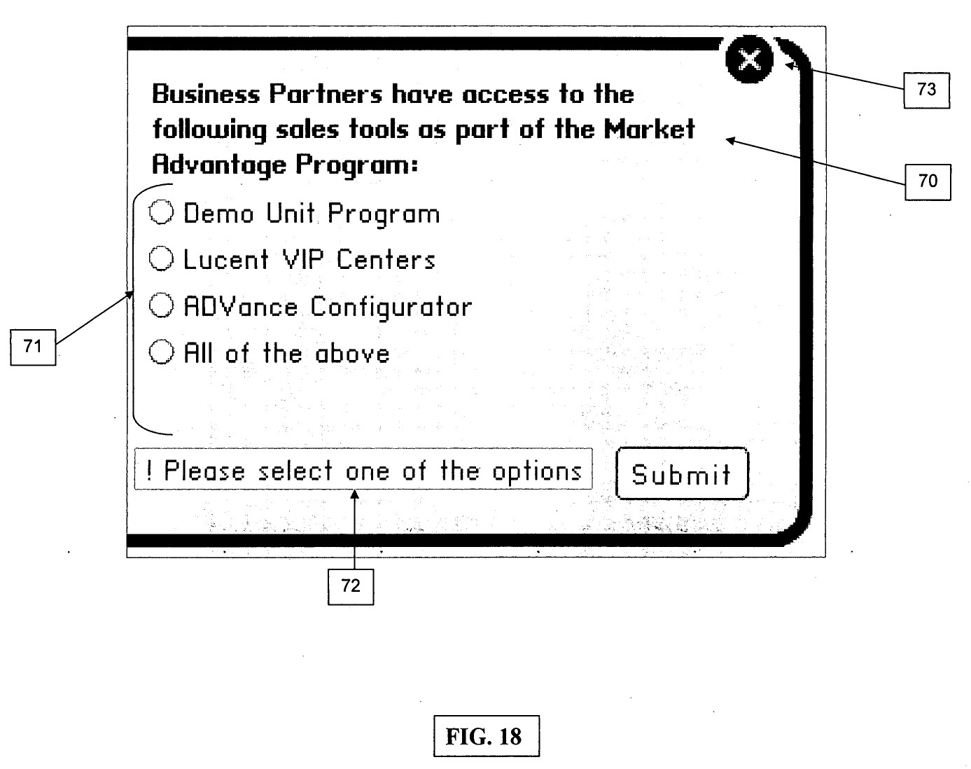

During an event the Administrator may incorporate user polls which the users may answer with their registered device. FIG. 1 and FIG. 17 show the embodiment of the method for polling. First, at a designated time during the event, the Administrator activates various polls on the system on an Administrator computer C. These polls are visible to the users on their registered devices A as pop up pages. An embodiment of this pop-up page is shown in FIG. 18. The pop up page directs each user to answer the displayed question or questions (70) by the means contained on the device for inputting data (71). The polls of the subject invention may contain one or more questions in multiple formats and may be voluntary or involuntary. If the poll is voluntary, the pop-up page may contain an icon for closing the page (73). If the poll is involuntary, the pop up page will prompt the user (72) to answer the poll before allowing the device to return to any other page. In additional embodiments of the subject invention, the device screen may hold consecutive poll pages in queue to allow the user time to finish consecutively received polls in the order in which they are received. The subsequent pop up poll pages will not appear on the device screen until the previous poll pop up page is completed. FIG. 18 shows an embodiment of the invention in which the user is prompted to display all received polls in consecutive order before allowing the user to return to any other page. In additional embodiments of the subject invention these poll results may be made available to the user on the registered device during the event and on the microsite after the event. FIG. 2 illustrates an embodiment of the polling within the system on the Poll Results page (PL0001).

As shown in FIG. 1, the users input poll data into the devices A. This data is sent to a local server B through a wireless network connection (1). The local server B hosts a number of applications to support this polling system including, but not limited to, a database server to store all data and content and web services that are consumed by the devices A to access poll results. For events with more than one location a data control application is used on the local servers B and on an additional global server E. The global server E is typically located in a remote data center location (2) and accessed over the Internet using web services utilizing the HTTP protocol. Local servers B can synchronize themselves with the global server E to send user generated polling data. The global server E tallies data and returns aggregate results to the local server B which in turn relays information to the users through the devices A.

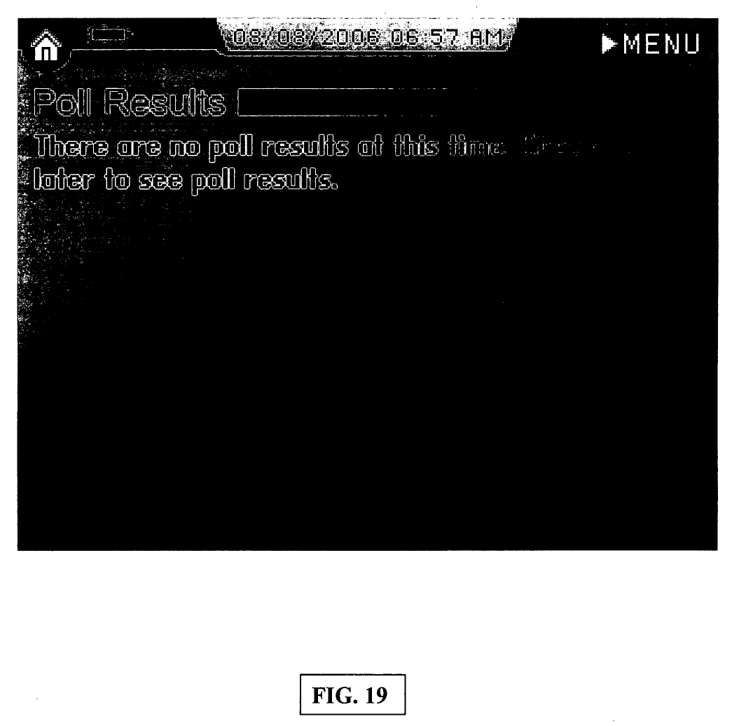

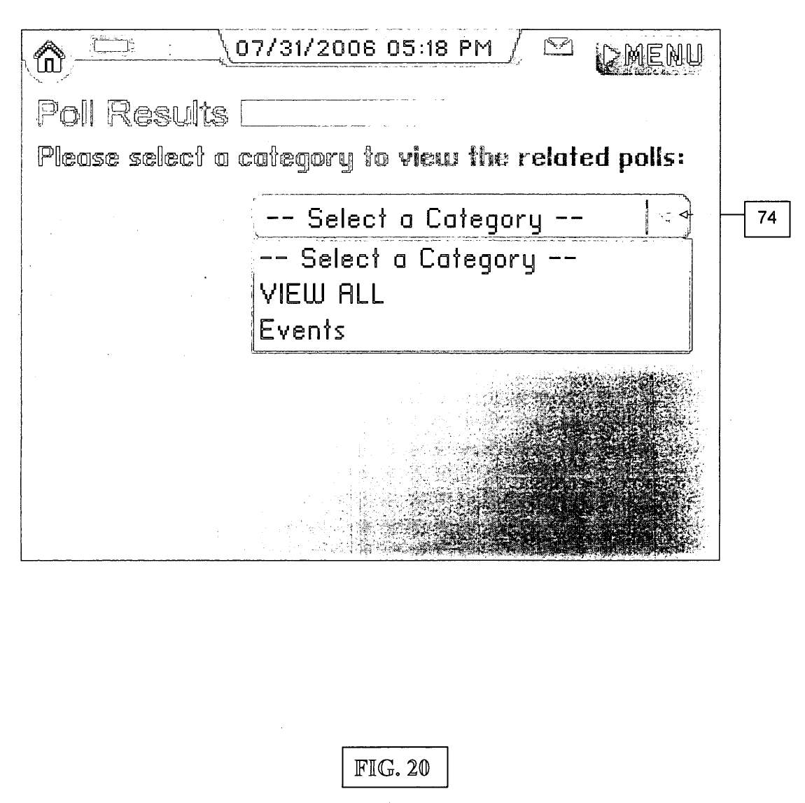

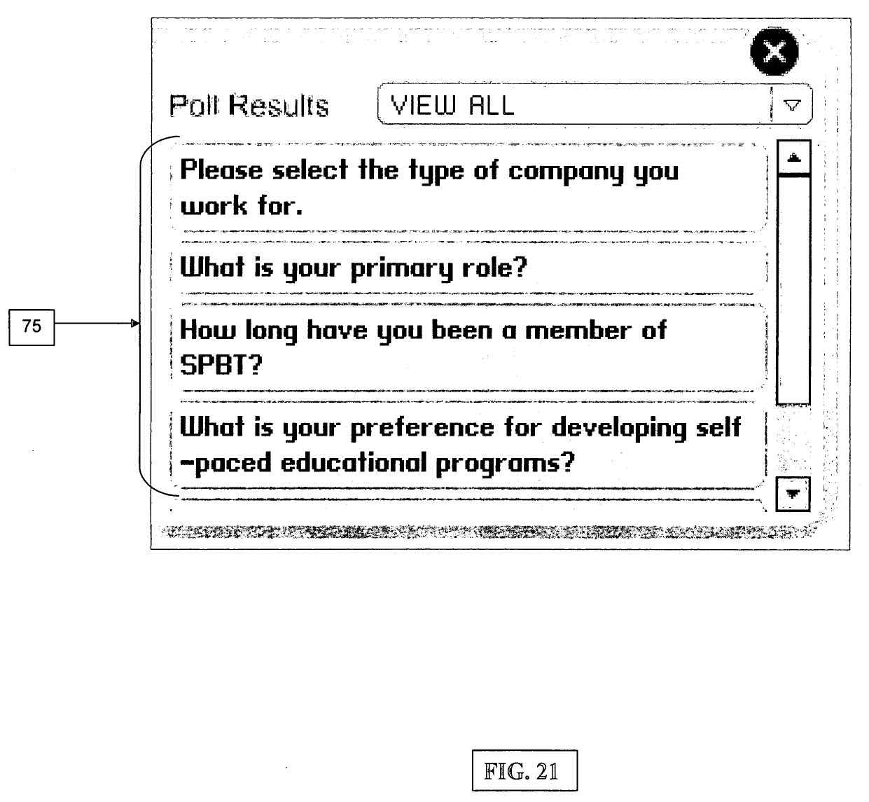

FIG. 19 details an embodiment of the Poll Results page (PL0001) on the user device if no results have been received from the local server B yet. FIG. 20 details an embodiment of the Poll Results page (PL0001) if there are results present and they have been grouped a pop-up menu (74) which allows the user to make a selection what result group details to view. FIG. 21 details an embodiment of the subcategory Poll Results page (PL1200 or PL1300 or PL1400). Each item (75) displays the question asked and links to the Individual Polls page (PL1210).

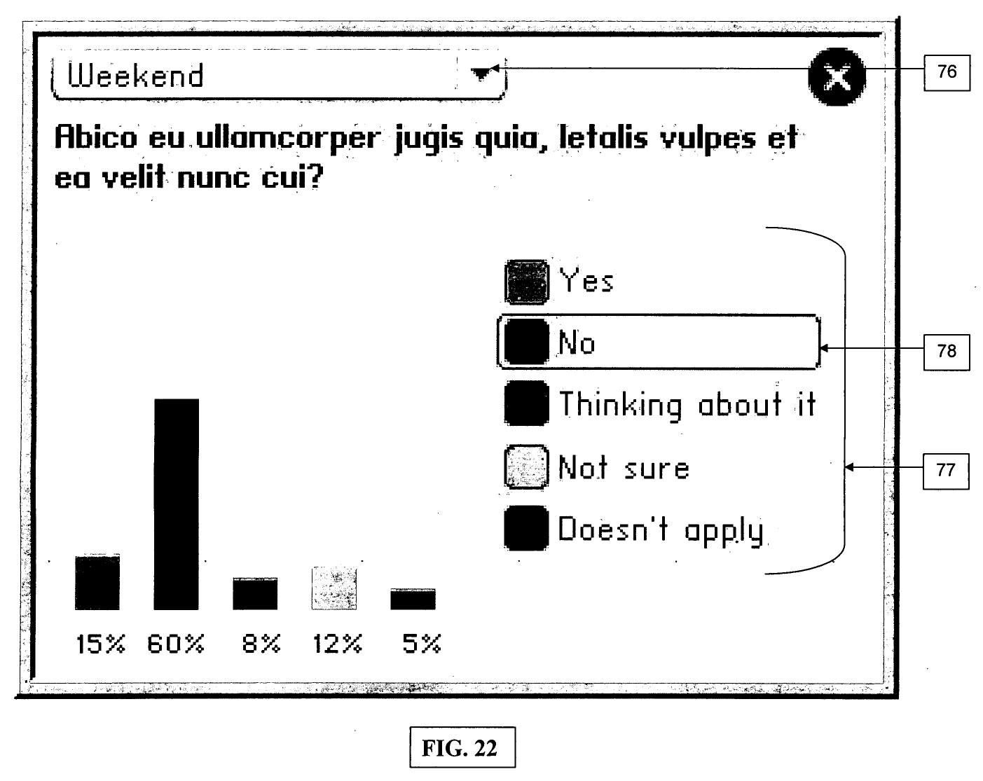

FIG. 22 details an embodiment of the Individual Polls page (PL1210). A pop-up menu (76) allows the user to select a presentation of the results. In additional embodiments of the subject invention, results presentations may be shown by any means known in the art, including, but not limited to representations of result data over time or by demographic, and charts or graphs that display the results as absolute tally counts or percentages (as shown). In this embodiment, a legend displays the answer choices (77) (color coded) and optionally indicates which was the correct answer (78) (“No” in this figure).

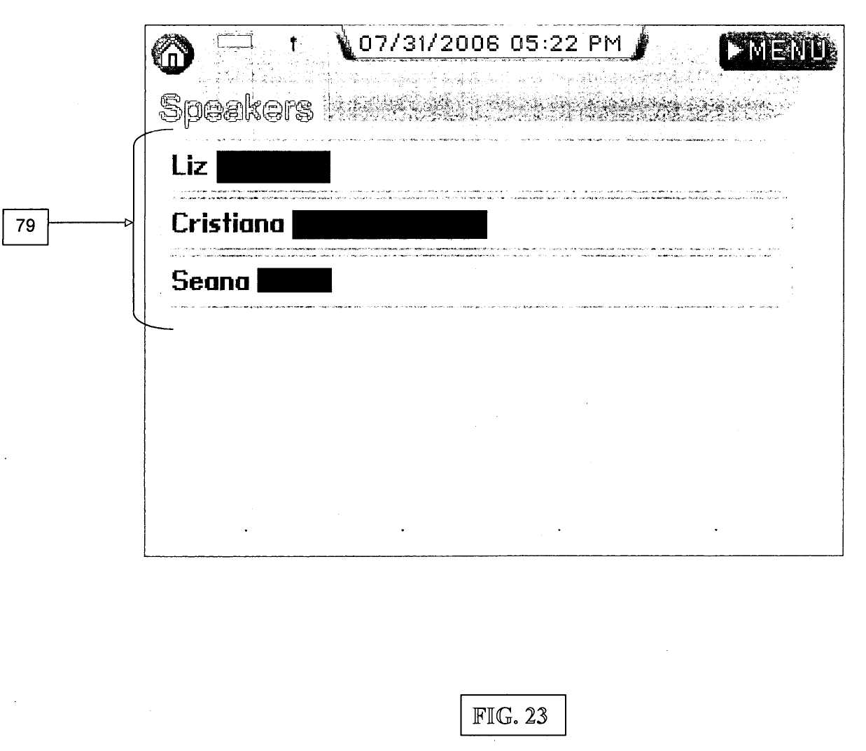

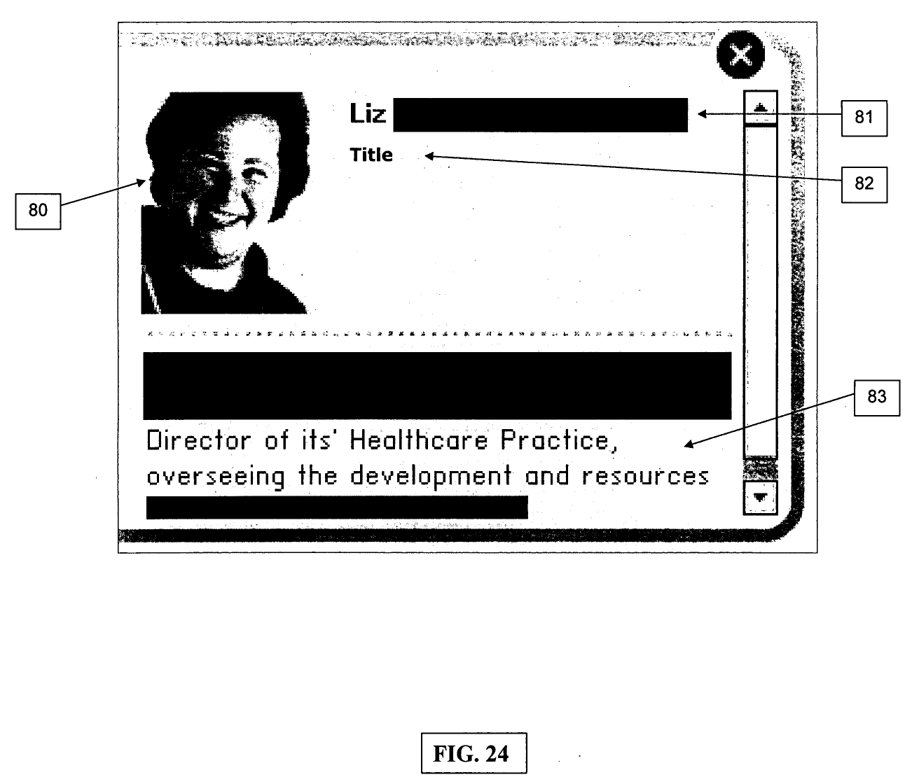

The embodiment of the subject invention illustrated in FIG. 2 also shows the Speakers page (SP0001) in which the names and details of the Speakers at the event are available for the user on the device. FIG. 23 details an embodiment of Speakers page (SP0001). In this embodiment the user can choose the speaker (79) of interest from a list with scrollbars appearing if needed. FIG. 24 details an embodiment of the Speaker detail page (SP1000). This page displays a picture (80) of the speaker if available, name (81), title (82) and description (83).

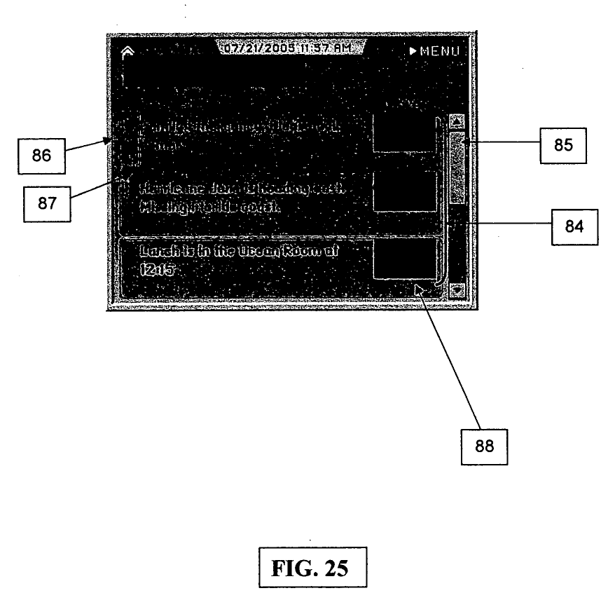

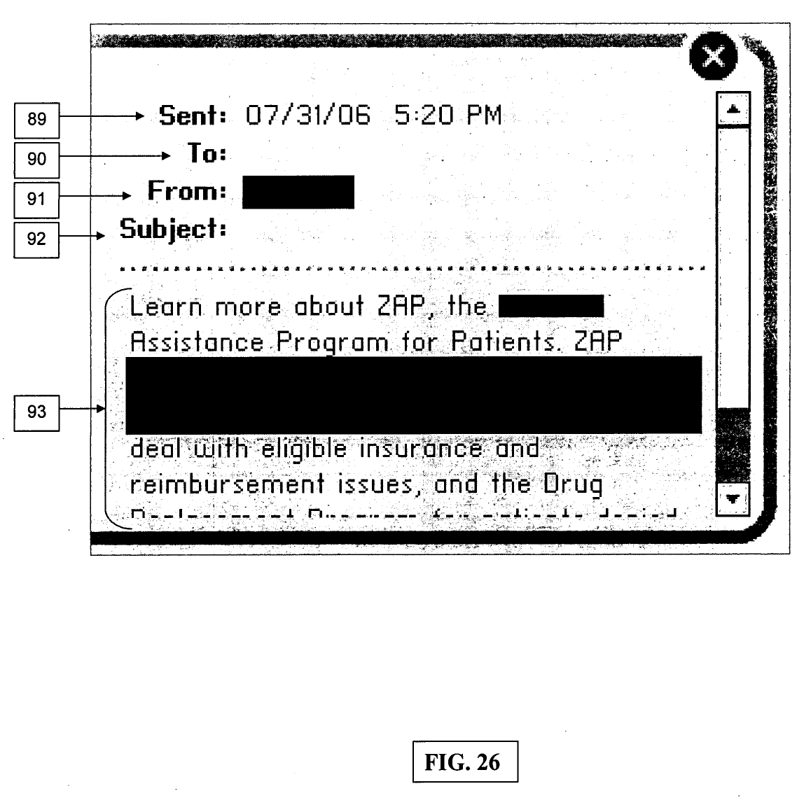

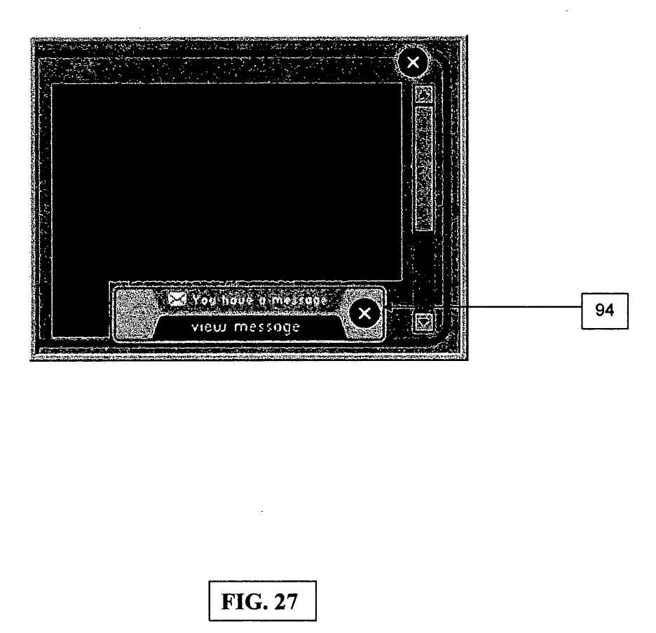

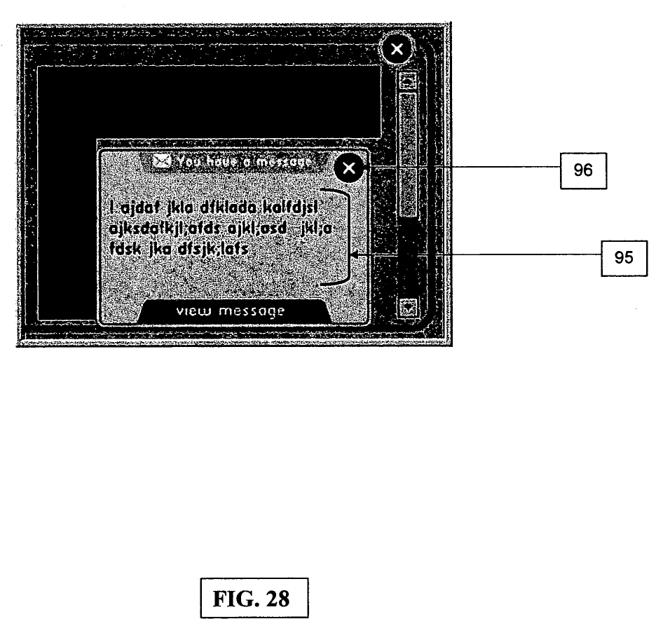

The embodiment of the subject invention illustrated in FIG. 2 further shows the Inbox page (IB0001) in which messages can be received by the user on the device from the local server B. FIG. 25 details an embodiment of the Inbox page (IB0001). This page lists any messages that have been received as a list (84) that optionally uses a scrollbar if needed (85). In this embodiment, each item displays the urgency (normal/high) (86), status (read) (not shown), subject (87), and date and time (88). When the user clicks on the item, the device displays the message detail page (IB1000). FIG. 26 details an embodiment of the message detail page (IB1000). The message detail consists of the date (89), time (89), sender list (91), recipient list (90), subject (92) and message body (93). The body may consist of text and/or images. FIG. 27 details an embodiment of a pop up page which appears on the device screen when a new message of normal priority arrives in the Inbox. Clicking on this popup leads directly to the message detail page (IB1000). Clicking on the close button (94) dismisses the popup without further action. FIG. 28 details an embodiment of a pop up page which appears on the device screen when a new message of high priority arrives in the Inbox. Any message sent is displayed directly (95). The popup page will not go away and all other options are blocked until the user dismisses it using the close button (96).

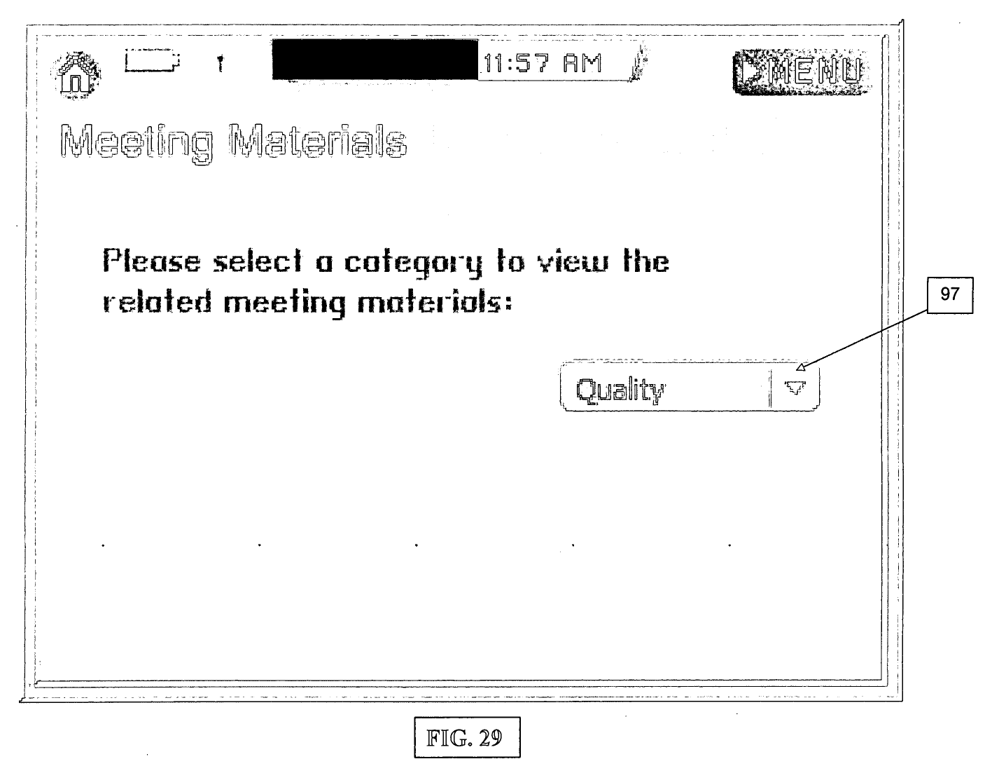

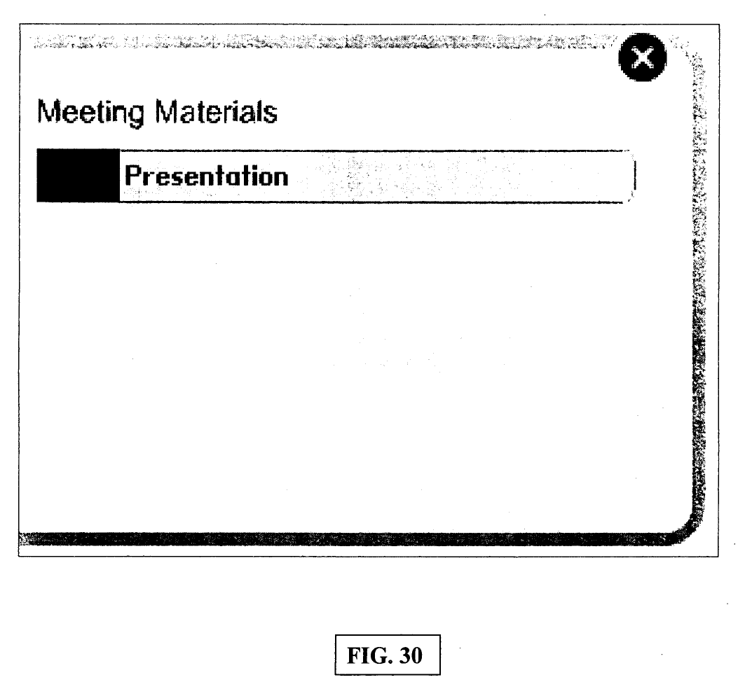

The embodiment of the subject invention illustrated in FIG. 2 even further shows the Meeting Materials page (MM0001) in which event materials can be distributed to user devices from the local server B. FIG. 29 details an embodiment of the Meeting Materials page (MM0001). Meeting materials may optionally be grouped (97) into subcategory pages, (e.g. “Quality”) accessed from the Meeting Materials page (MM0001). A user selecting a subcategory page leads to the meeting material subcategory page depicted in FIG. 30. If there are no groupings materials are listed directly as shown in FIG. 30. Clicking on a meeting material brings up a display of the item (text, image, presentation, video, external file) on the page.

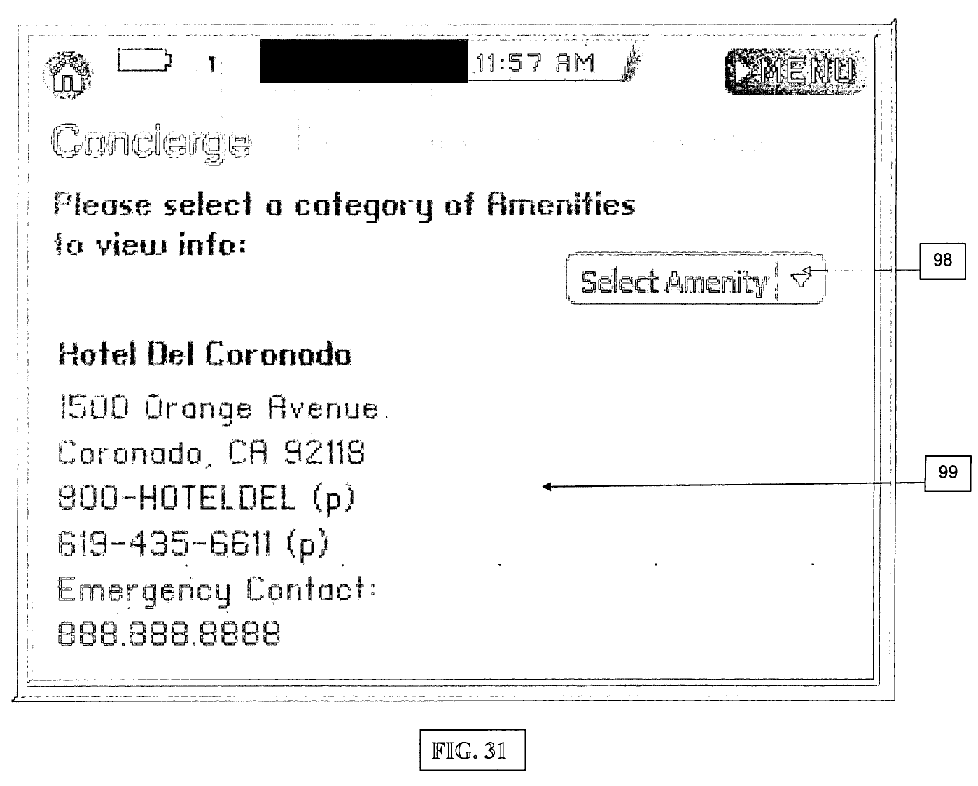

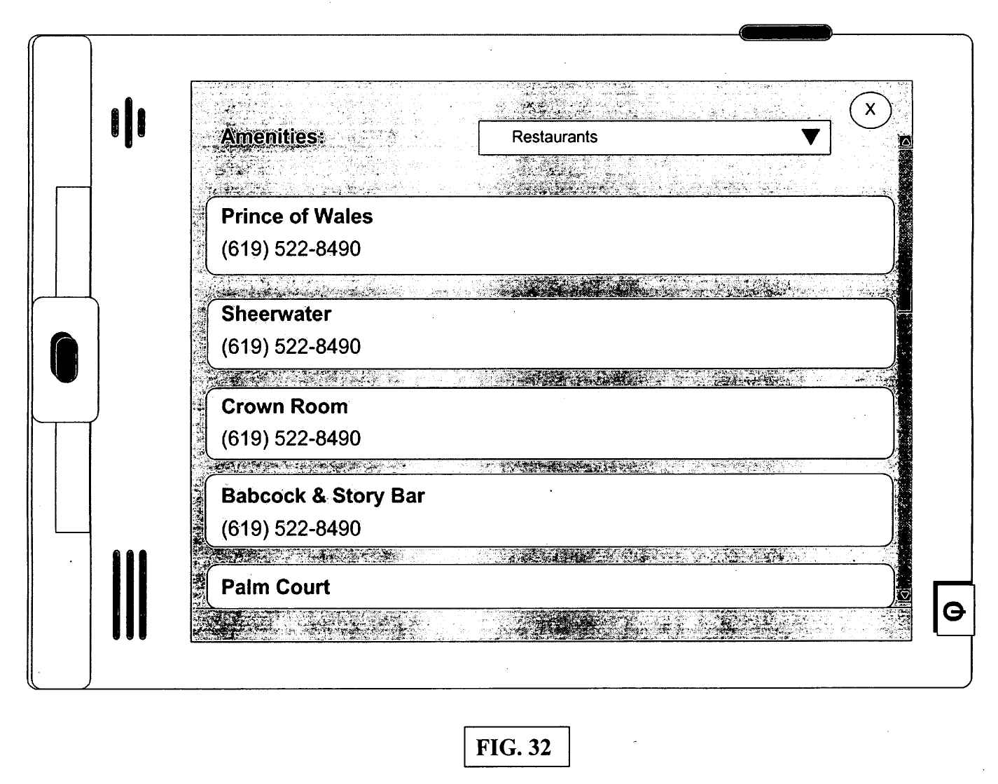

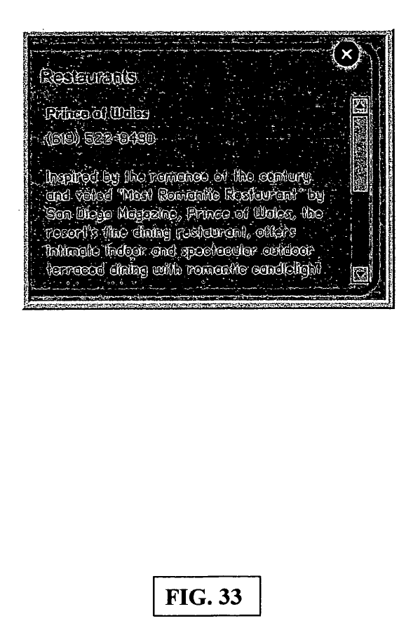

The embodiment of the subject invention illustrated in FIG. 2 also shows the Concierge page (CG0001) in which hotel and amenity information for the event may be obtained by the user on the device from the local server B. FIG. 31 details an embodiment of the Concierge page (CG0001), in which the default page displays the meeting venue (98). Using the pop-up menu (99) other amenity pages may be selected as shown in FIG. 32 or groups of amenities as shown in FIG. 33. In alternative embodiments of the invention, venue or amenity information can be textual with or without additional images.

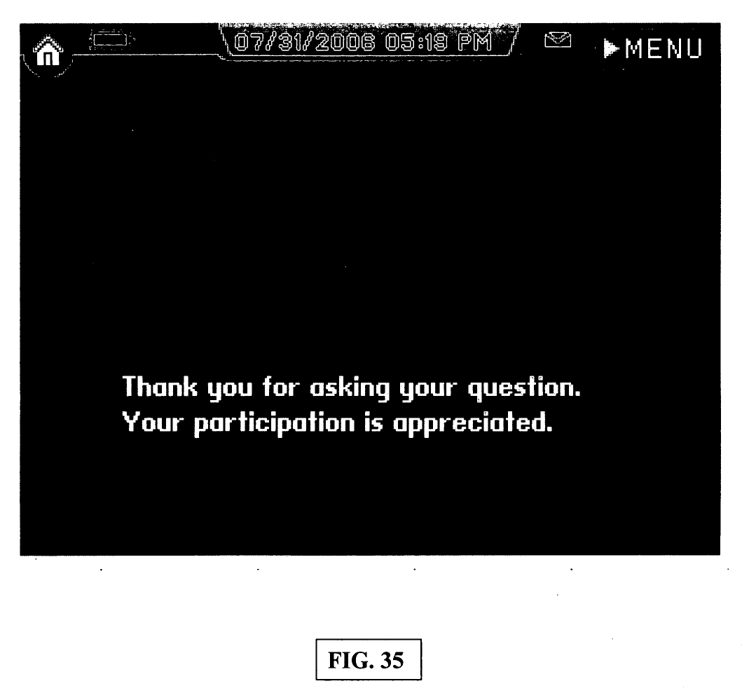

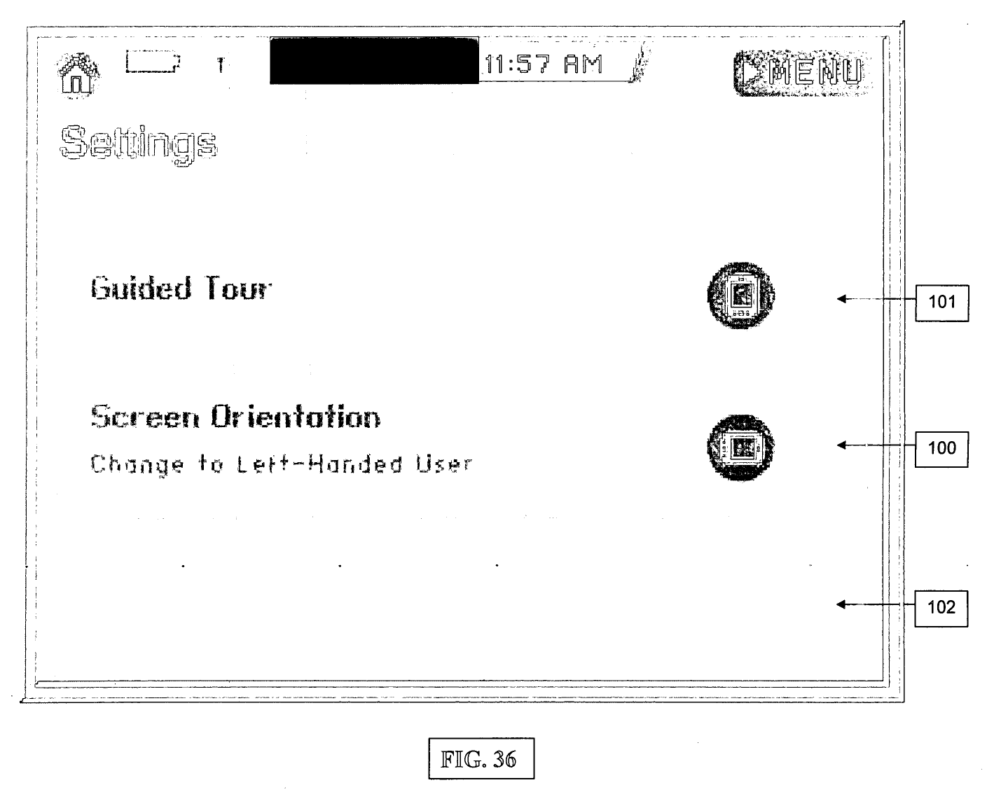

The embodiment of the subject invention illustrated in FIG. 2 further shows the Settings page (ST0001) in which the user may configure the display of the device or take a guided tour of the event using the device as a guide. FIG. 36 displays one embodiment of this Settings page. This Settings page lets the user configure device settings such as screen display orientation (100), access a guided tour (101) of how to use the system and optionally change the group they belong to. There is a hidden function that is accessed by clicking and dragging the pointer back and forth across the bottom of the Settings page (102) that allows Administrators to access further setting and troubleshooting pages.

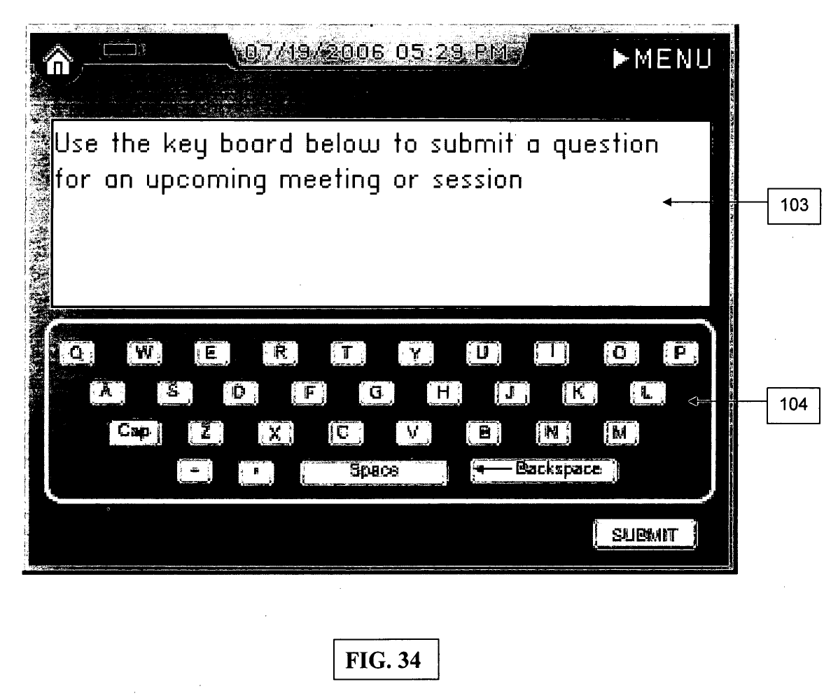

FIG. 34 illustrates an alternative embodiment of the subject invention which contains an “Ask a Question” page not displayed in FIG. 2. Using this page a user may submit a freeform question to the local server B which in turn is distributed to the Administrator computers D and the presentation computers C. The page provides as text box (103) for data entry as well as an on-screen keyboard (104). Not shown is an optional pop-up menu that allows the user to select whom to address the question to. Clicking “submit” on this page brings the user to a thank you page as shown in FIG. 35.

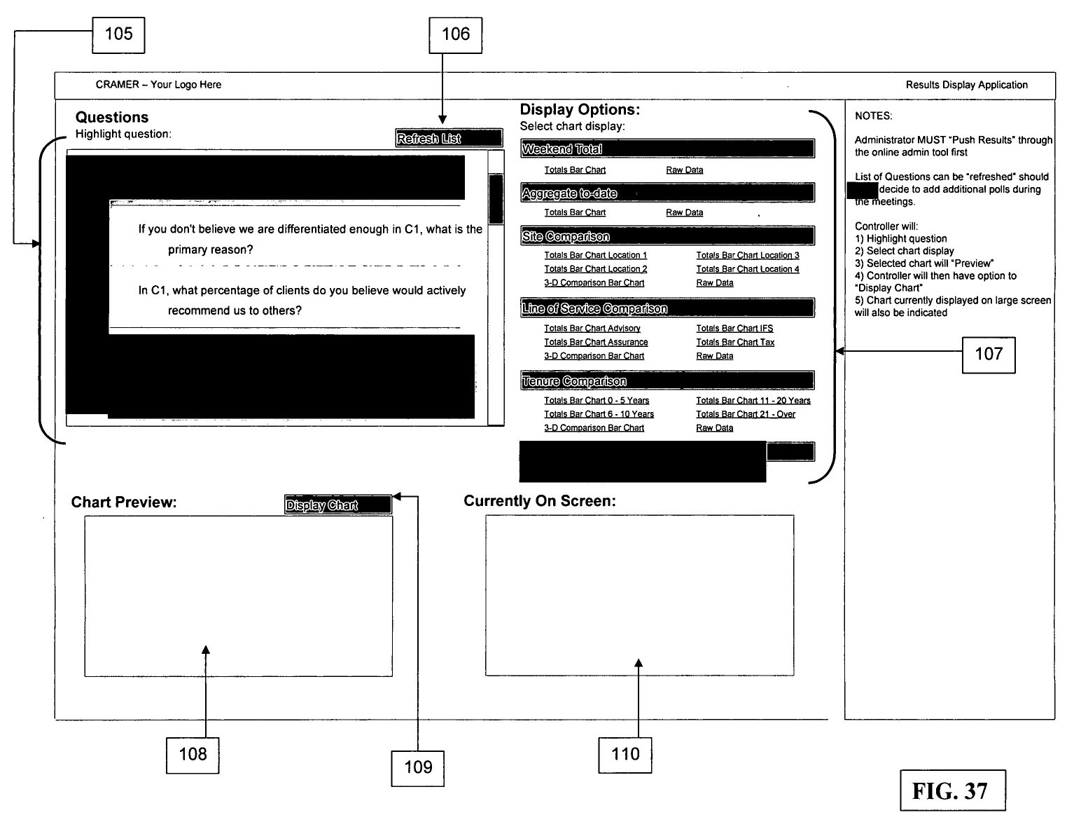

FIG. 37 illustrates an embodiment of the presentation application (a.k.a. Broadcast Results Application). Using this application on a laptop or desktop presenter computer C an presentation operator may select a poll question from a list (105). Items in the list become available as the poll results become available. The presentation operator may manually request a refresh of the list by clicking on the Refresh List button (106). After making a selection from the Questions list in the Display Options poll data and presentation options are retrieved from Server B or E as configured in a Presentation Application configuration file. A presentation operator may then select how poll data is presented by making a selection from Display Options area (107). Making a selection will cause the selected view to be shown in the Preview area (108). When the presentation operator clicks on the Display Chart button (109) the view is shown in the Currently On Screen area (110) and simultaneously on a second display device attached to the presenter computer C. This second display device is connected to a projection screen or a scan converted for broadcast as a television signal.

The views the presentation operator uses in this application are the same software components used in the devices (A) and microsite.

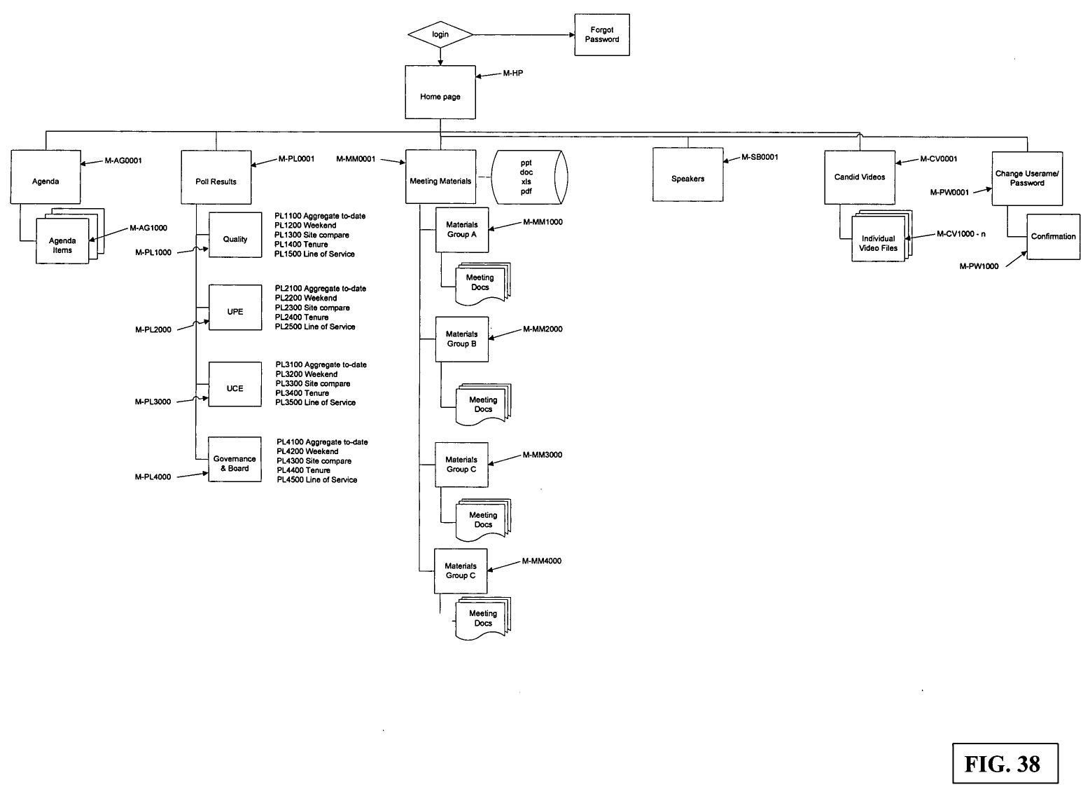

FIG. 38 details an embodiment of the micro site overall site map. In this embodiment the site map contains a login webpage and password retrieval webpage before the home webpage. The site map further contains an agenda and agenda item detail webpage; a poll results webpage with sub-pages for groups of polls and indications for poll display options per poll item; a meeting materials webpage and sub-pages for groups of materials with indications of links to materials; a speakers listing webpage; a video viewing webpage with an indication of ownership of multiple videos; a change username and password webpage with a confirmation webpage.

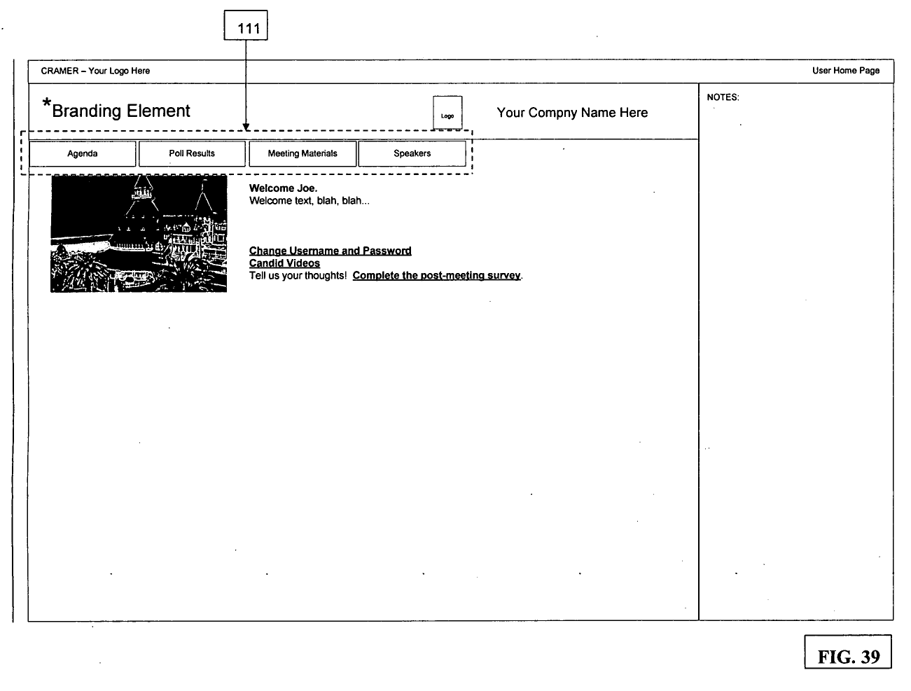

FIG. 39 details the embodiment of the welcome webpage on the microsite. This embodiment allows the user to select between one or more of various functions classified into categories (111). FIG. 38 illustrates one embodiment of the category webpages available to the user including: an Agenda webpage (M-AG0001), a Poll Result webpage (M-PL0001), a Speakers webpage (M-SB0001), a Meeting Materials webpage (M-MM0001), a Candid Videos webpage (M-CV0001), a Change Username/Password webpage (M-PW0001). In additional embodiments of the subject invention the user may access all or some of these category webpages. In further embodiments of the subject invention, fewer or additional category webpages may be incorporated into the system.

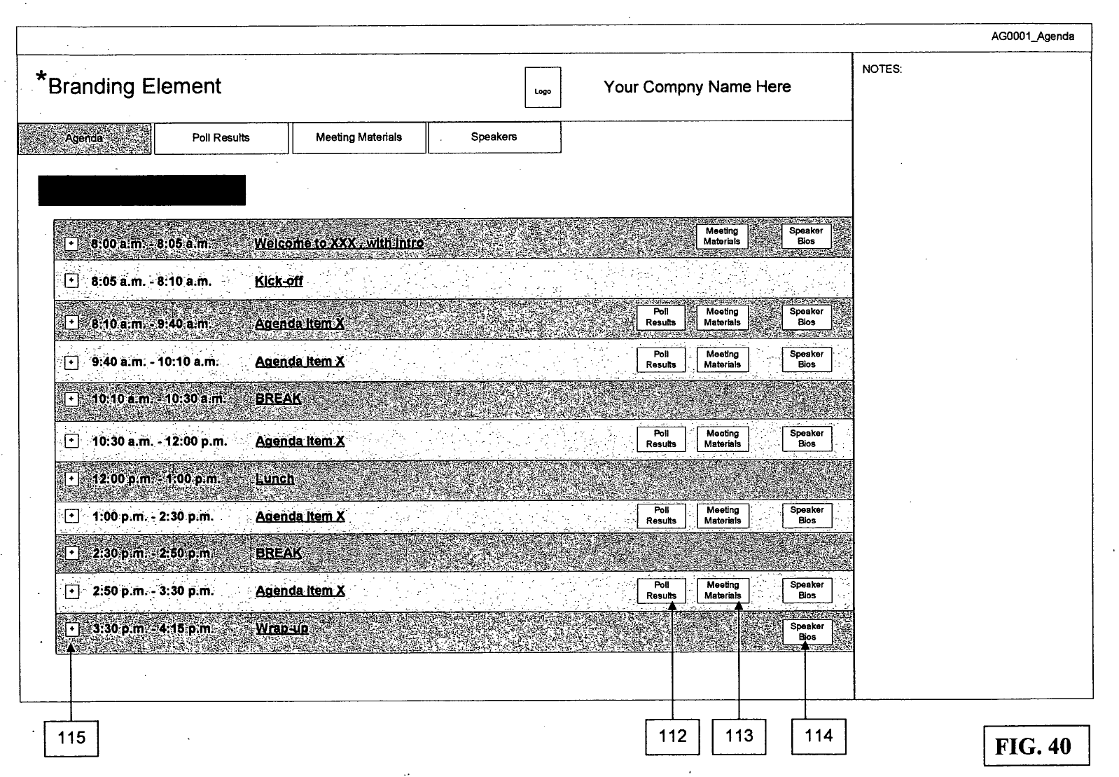

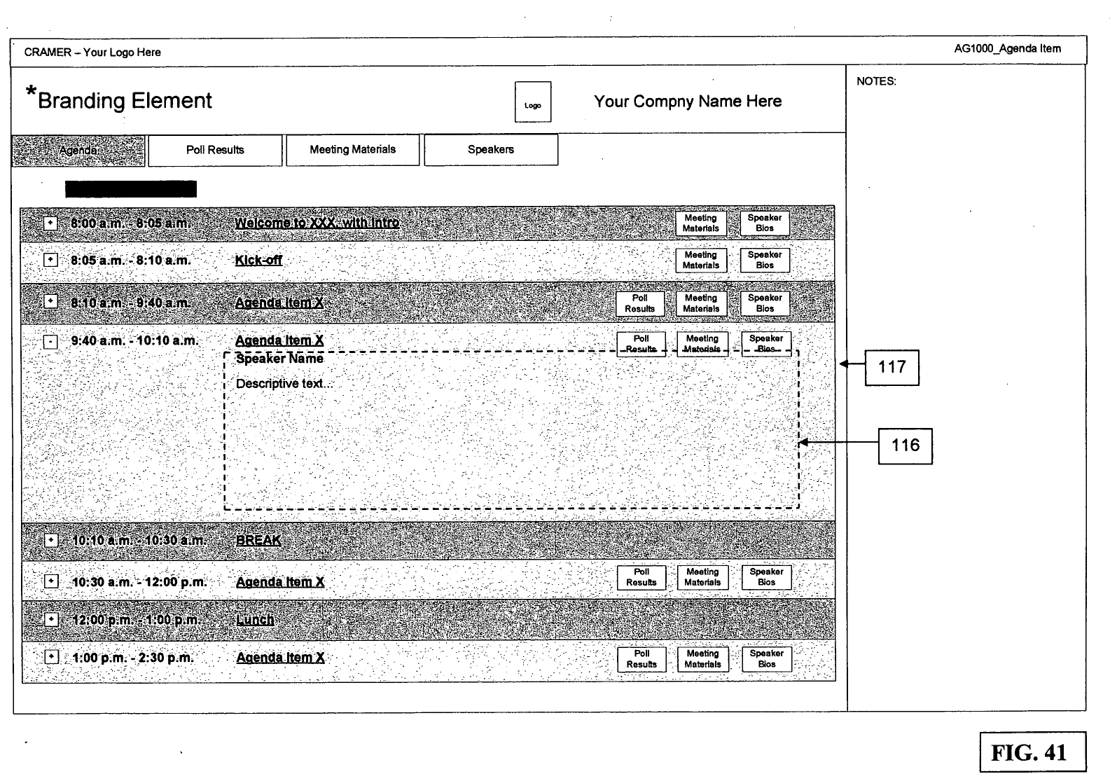

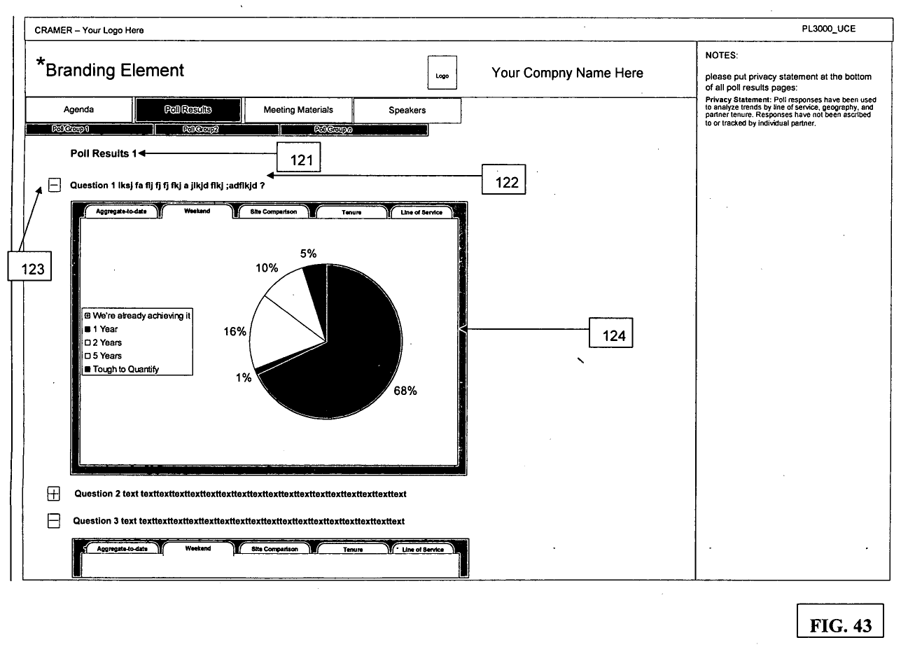

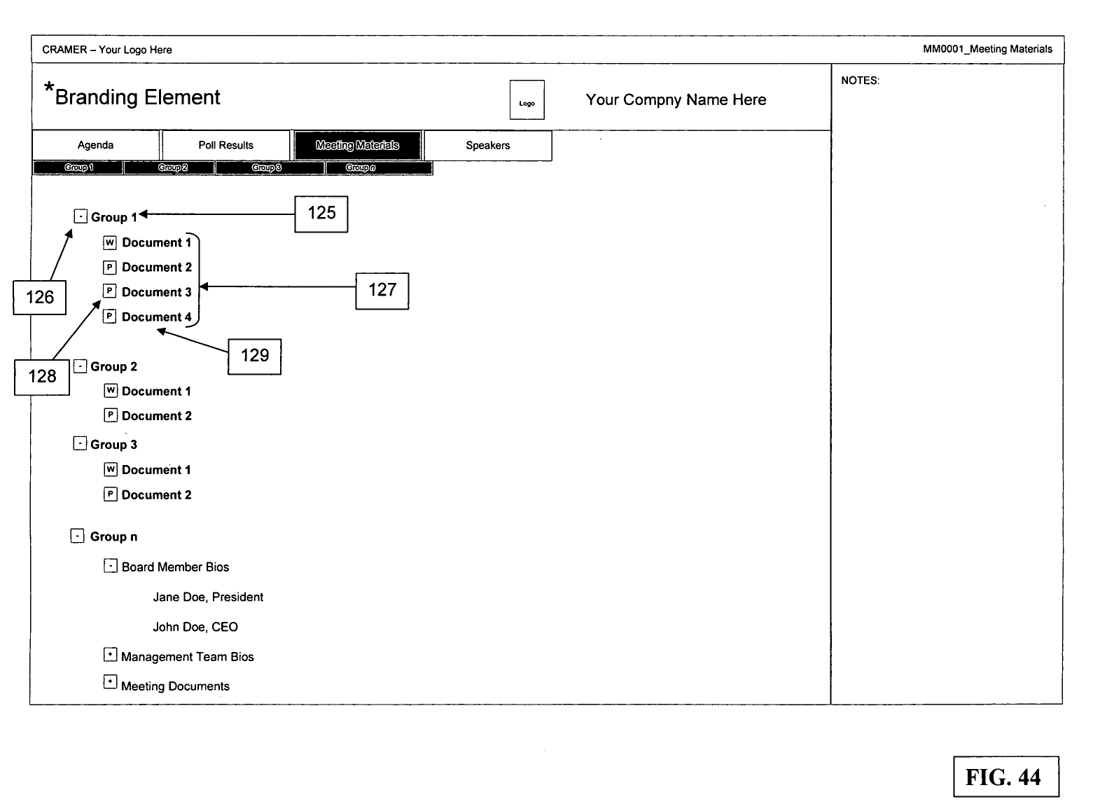

FIG. 40 details an embodiment of the Agenda webpage (M-AG0001). The times and dates of each agenda item are listed, as well as the title. Further, for each agenda item listed icons indicating the availability of poll results (112), meeting materials (113) and speakers (114) may appear. Additionally each agenda item shows an icon (115) that is a link which allows the user to expand the agenda item to reveal additional items (116) as shown in FIG. 41. Clicking on the poll results link brings the user to poll results webpage (M-PL0001) shown in FIG. 43. Clicking on the Meeting Materials link (113) brings the user to the relevant meeting materials webpage (M-MM0001) shown in FIG. 44. Clicking on speaker names (114) displays a pop-up page (M-SB0001) shown in FIG. 41A.

FIG. 41 details an embodiment of the Agenda webpage (M-AG0001) with an expanded agenda item (117). Additional information (116) may consist of speaker names, material titles, poll questions and additional descriptive text that may contain links.

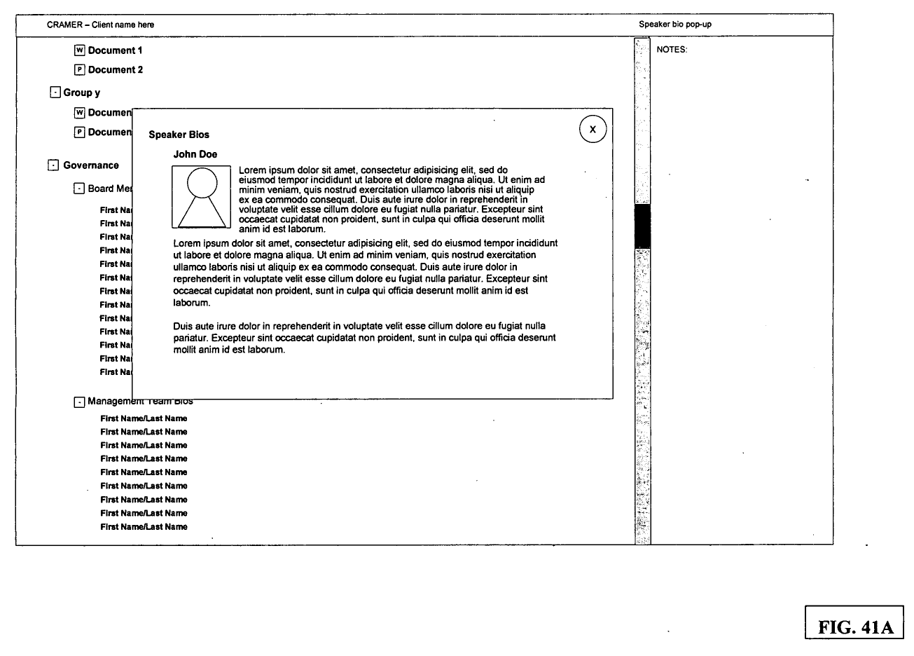

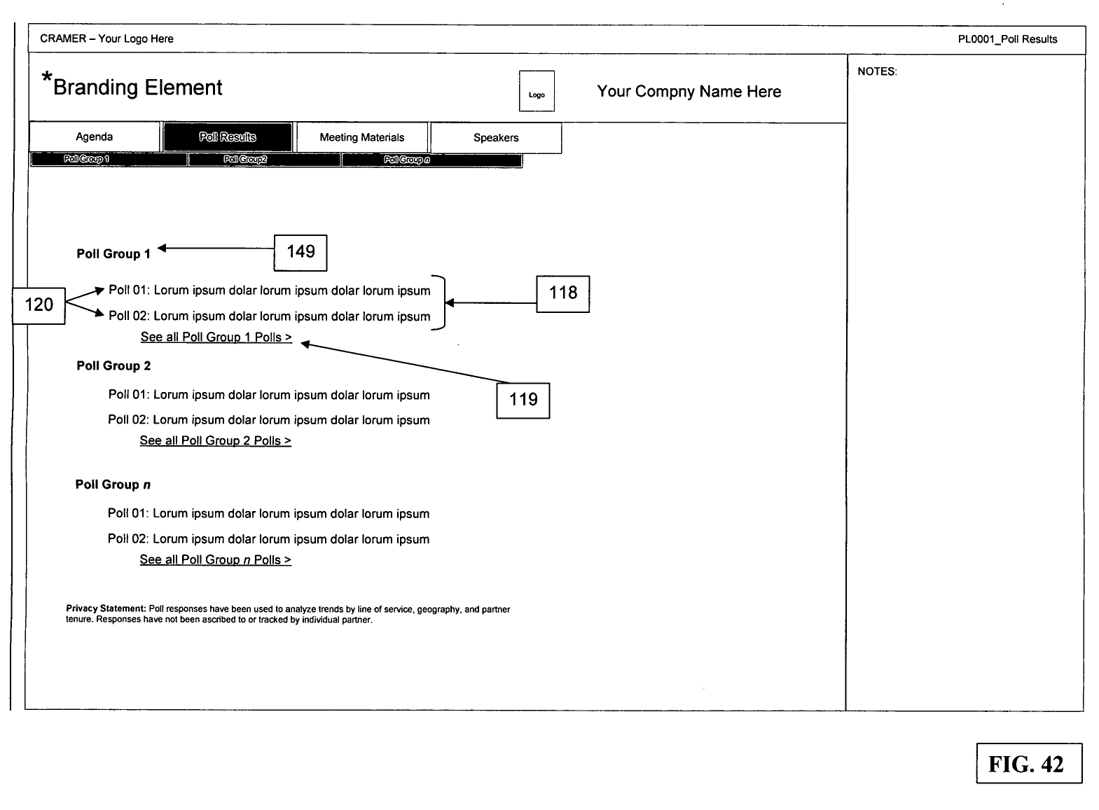

FIG. 42 details an embodiment of the Poll Results webpage (M-PL0001). This embodiment displays an overview of the available poll result sets. Each poll result set listing consists of a poll group title (149) and a sampling of the first few questions in that grouping (118). Each poll group further has a link (119) that leads to the poll group detail webpage shown in FIG. 43. The name for the poll group typically is the name of the agenda item the poll is associated with. This embodiment further provides navigational links (120) using the titles of poll result sets allow for direct navigation to the relevant poll group detail webpage shown in FIG. 43.

FIG. 43 details an embodiment of a poll group detail webpage. This embodiment displays the title of the poll result set (121) and at least one poll question (122). Further for each poll question the text of the question and an expand/collapse indicator (+/−) (123) are links that will reveal an embedded Flash poll result presentation component (124). This poll result presentation component is the same and as described in FIG. 22. Further yet this webpage provides navigational links using the titles of poll result sets allow for direct navigation to the relevant poll group detail webpage shown in FIG. 43.

FIG. 44 details an embodiment of a top level meeting materials webpage (M-MM0001). This embodiment displays an overview of the available meeting materials groups (125). The text of each meeting material group as well as a graphical expand/collapse (126) indicator are links to that when clicked reveal a listing (127) consisting of available materials. Each material item listing is a link (129) that will cause a corresponding file to be downloaded or displayed in the user's Internet browser. Each material item listing further displays an icon (128) that indicated the type of document and also acts as a link that will cause a corresponding file to be downloaded or displayed in the user's Internet browser.

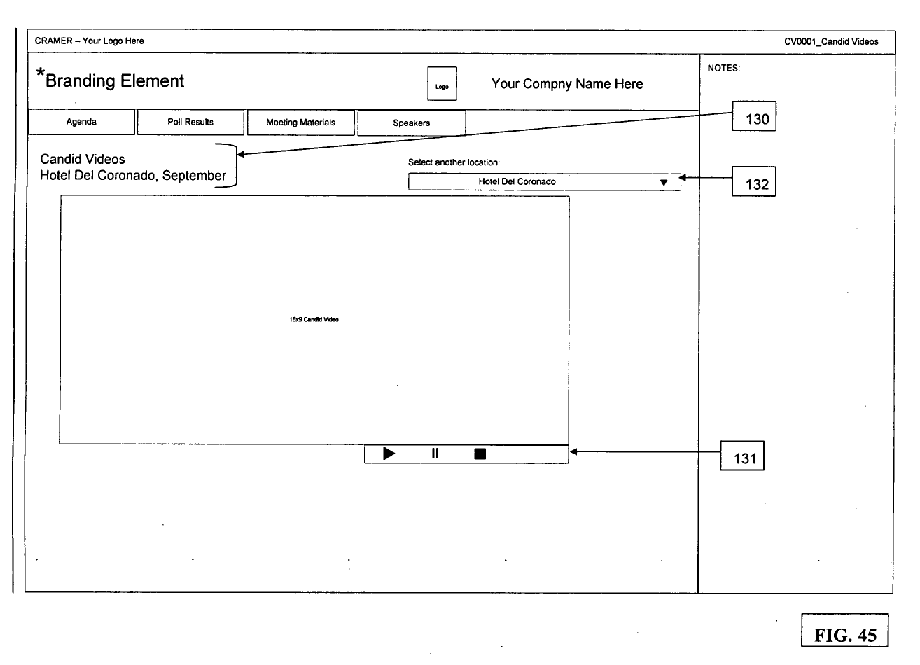

FIG. 45 details an embodiment of a candids video webpage (M-CV0001). This embodiment displays the location and date of the video (130). The video is embedded in the webpage and provides controls for playing, pausing, stopping and scrubbing the video (131). Further this embodiment provides a navigational aide (132) (popup webpage) that allows the user to select another available video if available.

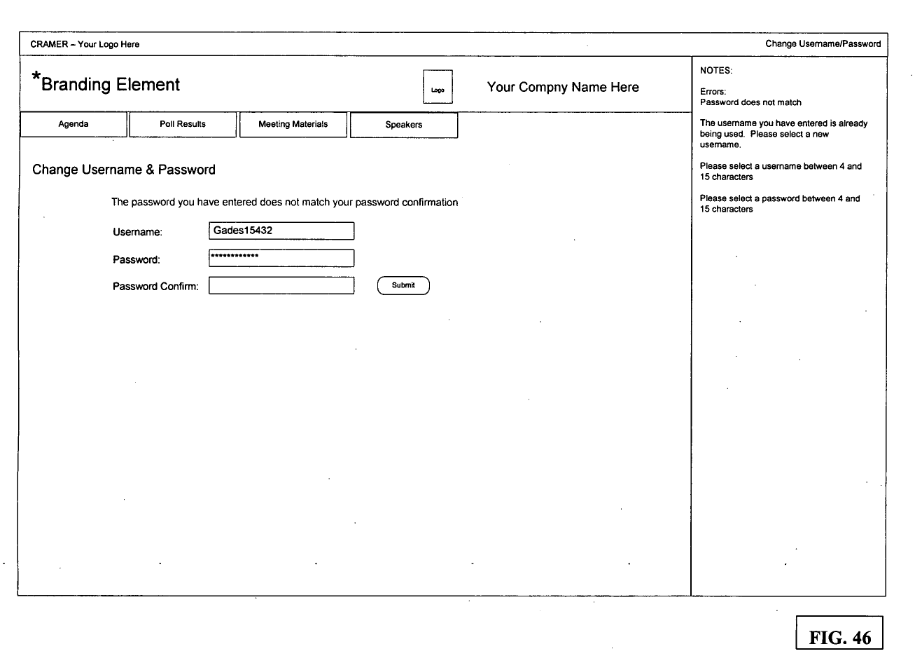

FIG. 46 details an embodiment of a change password webpage (M-PW0001). This embodiment displays instructions and provides data entry boxes that display and let the user change their username and password. Passwords are obfuscated and password entries are required to be entered twice. This embodiment further contains a submit button, that when clicked will submit changes to the server.

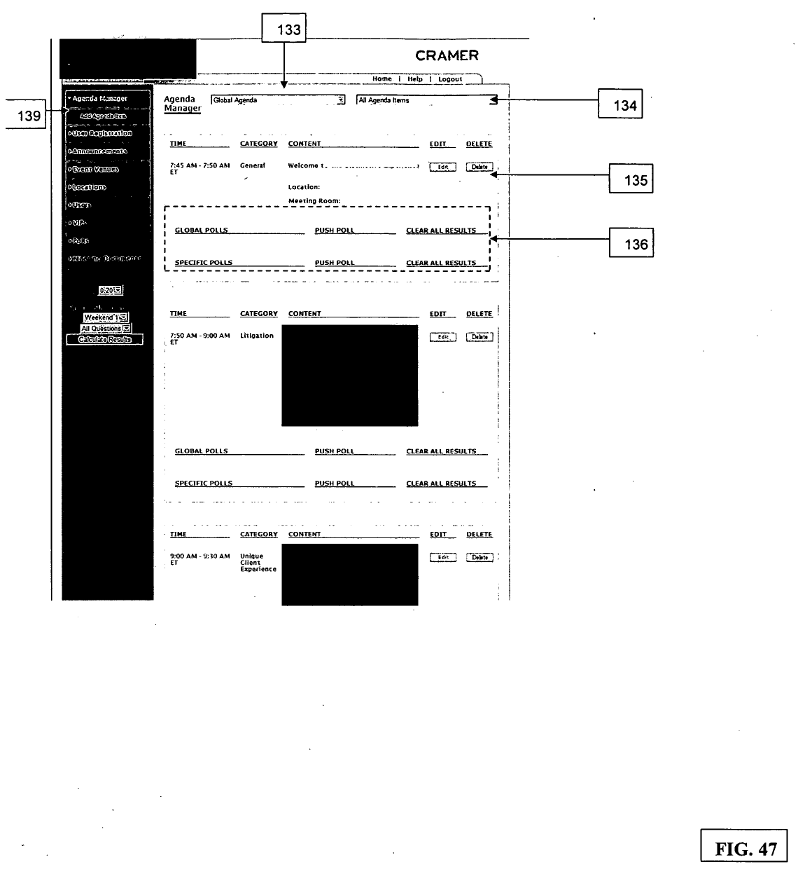

FIG. 47 details an embodiment of the administration site agenda overview webpage (M-AG0001). This embodiment contains a pop-up menu (133) that allows the administrator to select from a list of one or more agendas. From the list of agenda item choices the administrator may select a special menu item titled “Global Agenda”. The “Global Agenda” is an agenda that is not associated with a physical location and whose agenda items are by default available to all other agendas. If a normal agenda defines an agenda item that covers the same time period as a “Global Agenda” item the normal agenda item supersedes the global agenda item.

The embodiment further contains a pop-up menu (134) that allows the user to select one agenda item from a list of agenda items available from the selected agenda. Selecting an individual agenda item will cause the display of only that one agenda item. By default a special item titled “All Agenda Items” is selected. Selecting this special item will cause the display of all agenda items.

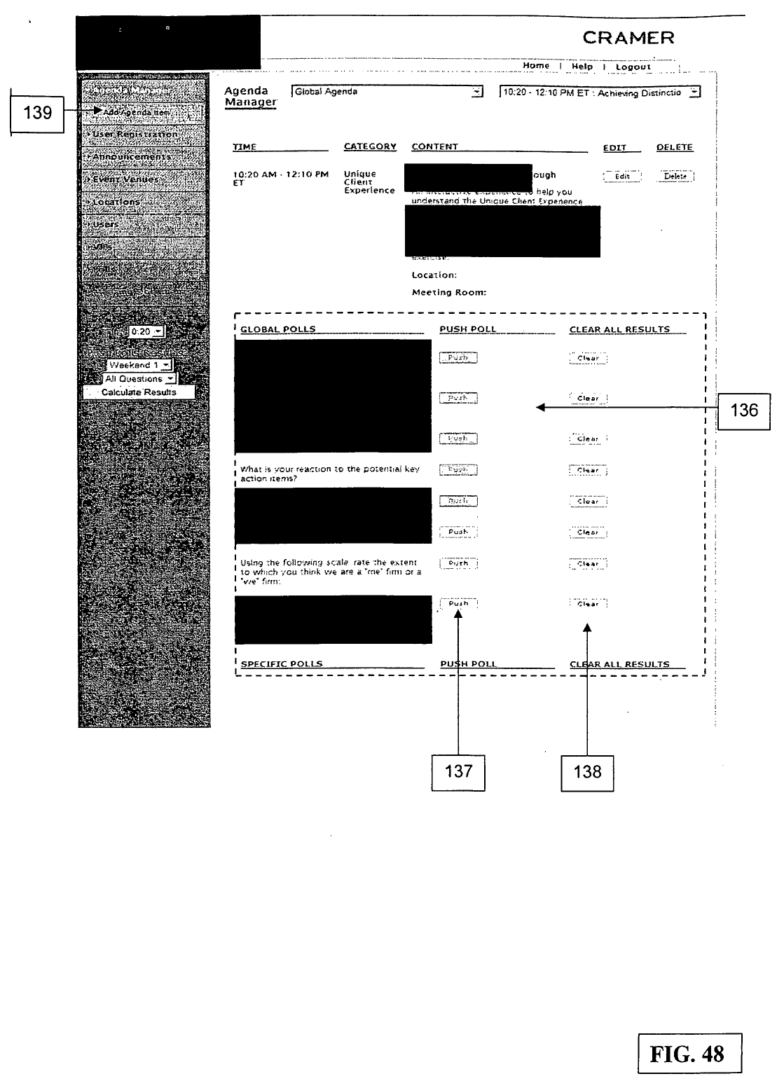

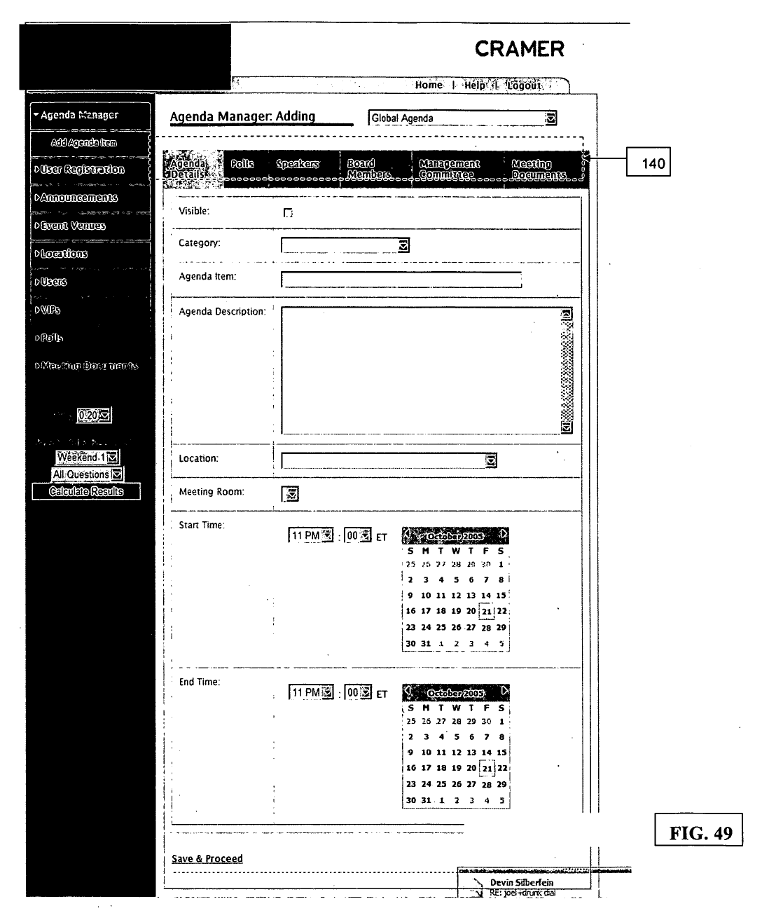

Further yet the embodiment displays zero or more agenda item sections (135). Each agenda item section displays agenda item time, category, description, location, meeting room, speakers, poll section as well as Edit and Delete buttons. Clicking on the Edit button will lead the administrator to the agenda item add/edit webpage (shown in FIG. 49). Clicking on the Delete button will present the user with a confirmation dialog that, when affirmed in the positive will cause the removal of the agenda item from the selected agenda. Each agenda item's poll section (136) shows zero or more poll questions, poll “push” button (137) and a poll results “clear” button (138) as shown in FIG. 48. Clicking on the “Push” button will cause the poll question to be sent and subsequently presented on the handheld devices. The poll “Push” button appears grayed (FIG. 48) after a poll has been pushed.

Further again this embodiment adds an “Add Agenda Item” link (139) to the global navigation scheme. Clicking this link will bring the user to the add/edit agenda item webpage (shown in FIG. 49).

FIG. 48 details an alternative embodiment of the administration site agenda overview webpage (M-AG0001). This embodiment show a single agenda item selected from the global agenda for a particular timeslot. This embodiment further shows the display of multiple poll items with poll “Push” buttons in the un-sent and pushed states.

FIG. 49 details an embodiment of the add/edit agenda item webpage. This webpage allows the administrator to select which agenda is being edited/added to. Further this webpage allows the administrator to toggle visibility, select a category, enter an agenda item title and description, select a location and meeting room as well as select start and end time and date. A Save & Proceed link will cause the record to be stored. A menu (140) above the data entry area allows the administrator to switch to further data entry webpages that allow selection of polls, speakers and meeting materials relevant to the agenda item.

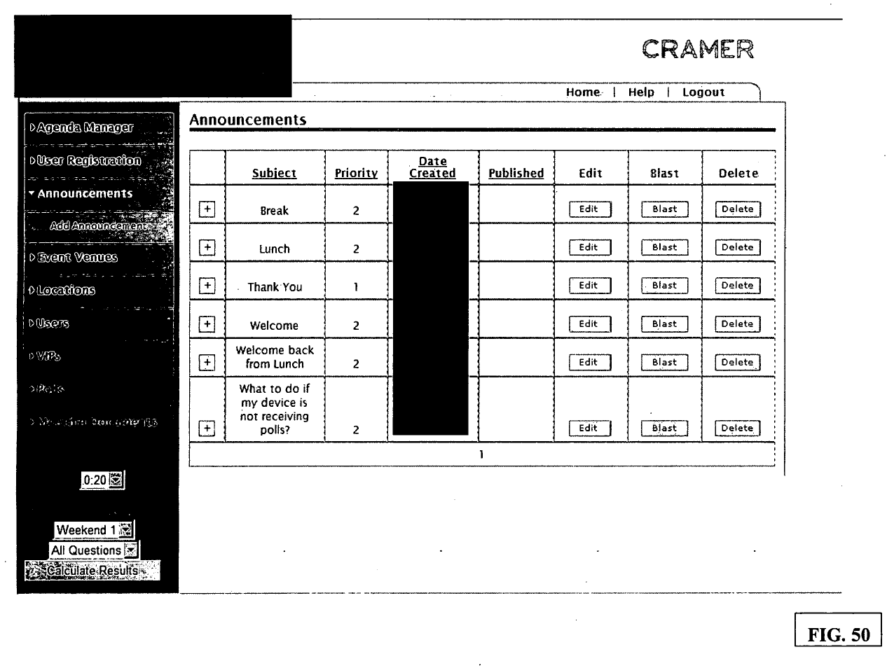

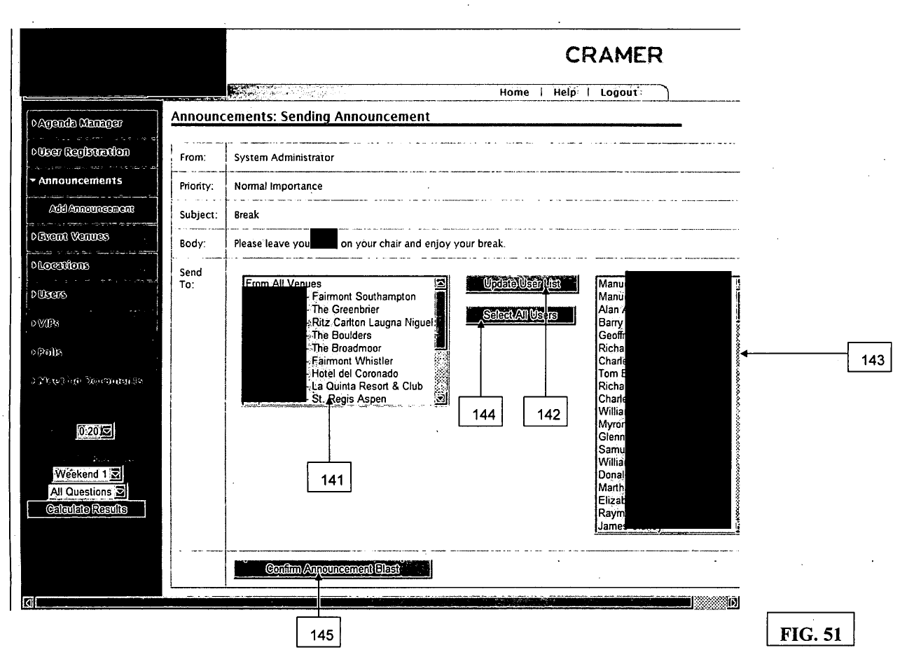

FIG. 50 details an embodiment of the announcement listing webpage. The question, priority, creation date, publish date as well as buttons that link to edit, blast (send) and delete functions are listed. Clicking the blast button leads the user to the send announcement webpage (shown in FIG. 51). Clicking on the delete button will display a confirmation dialog asking for confirmation of the delete action, that when answered in the positive will cause the related records to be deleted from the database.

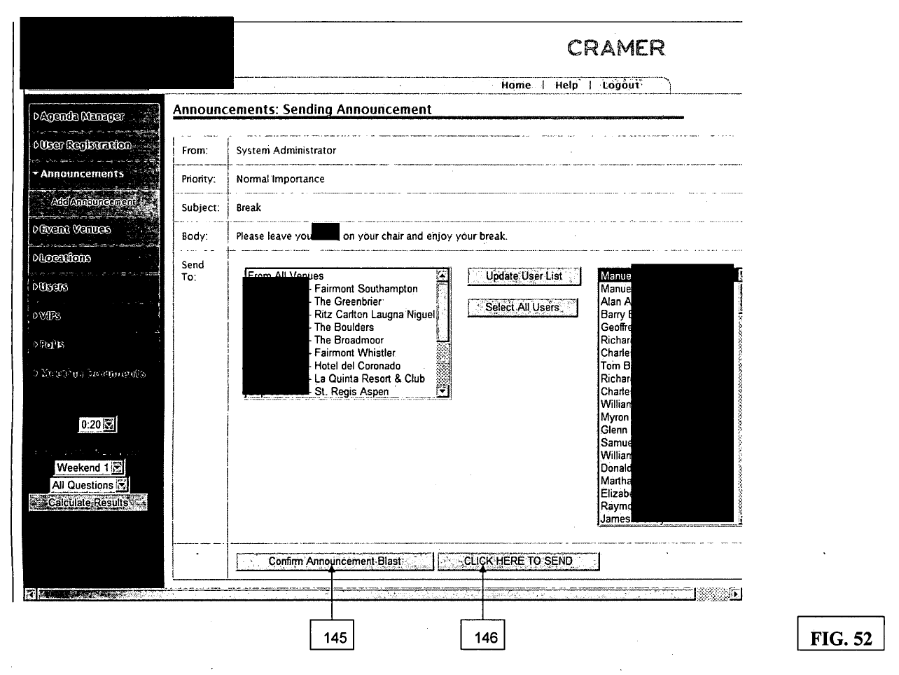

FIG. 51 details an embodiment of the send announcement webpage. The sender, priority, subject and body of the message are displayed. The area labeled “Send To” allows the administrator to select one or more target venues from a list (141). Clicking on the “Update User List” button (142) will display all users assigned to the selected venues. The administrator may then proceed to select one or more users from the list of users (143). By clicking on “Select All Users” (144) all available user in the user list area can be selected at once. Clicking on the “Confirm Announcement Blast” (145) will add the “Click Here To Send” (146) button show at the bottom of FIG. 52.

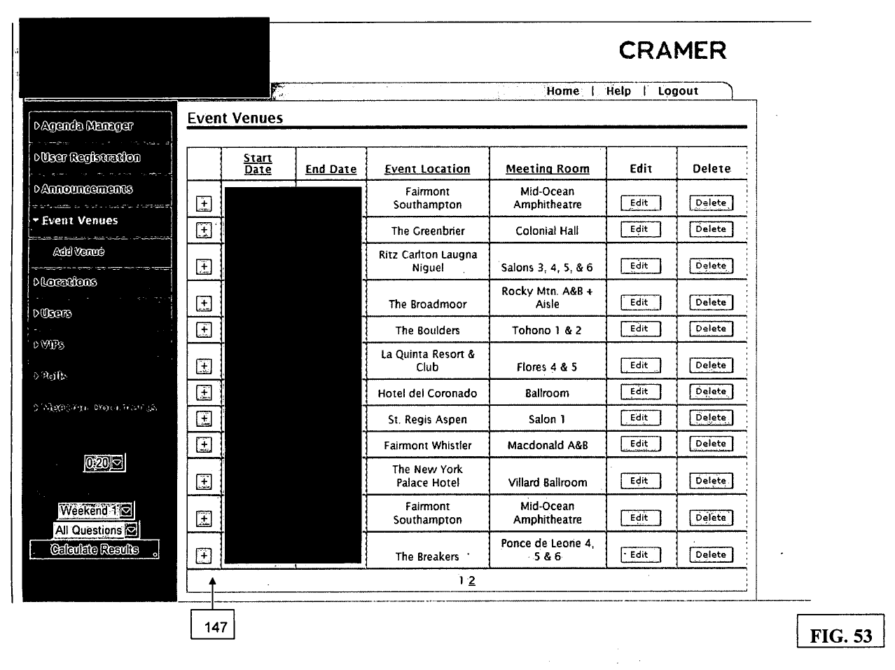

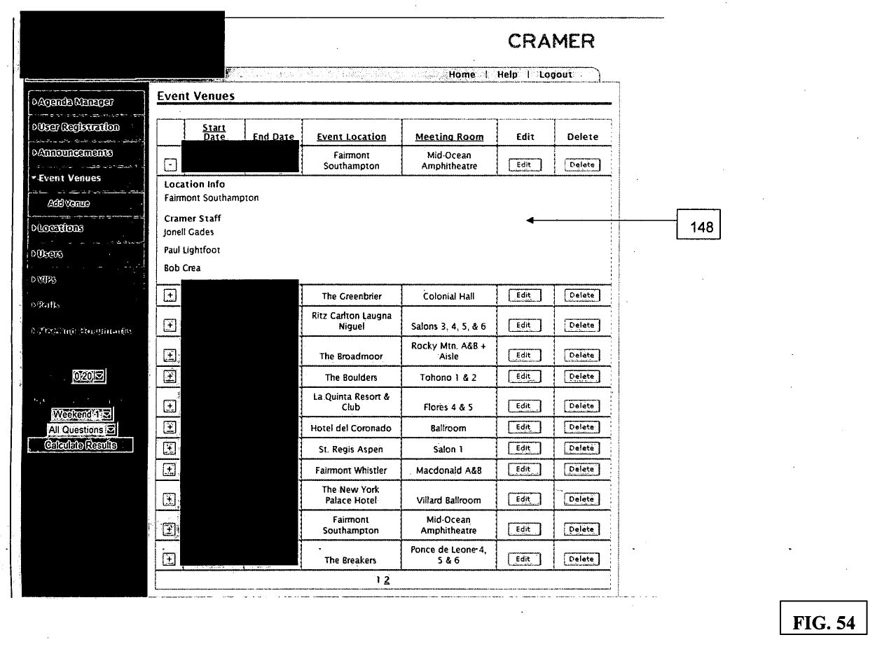

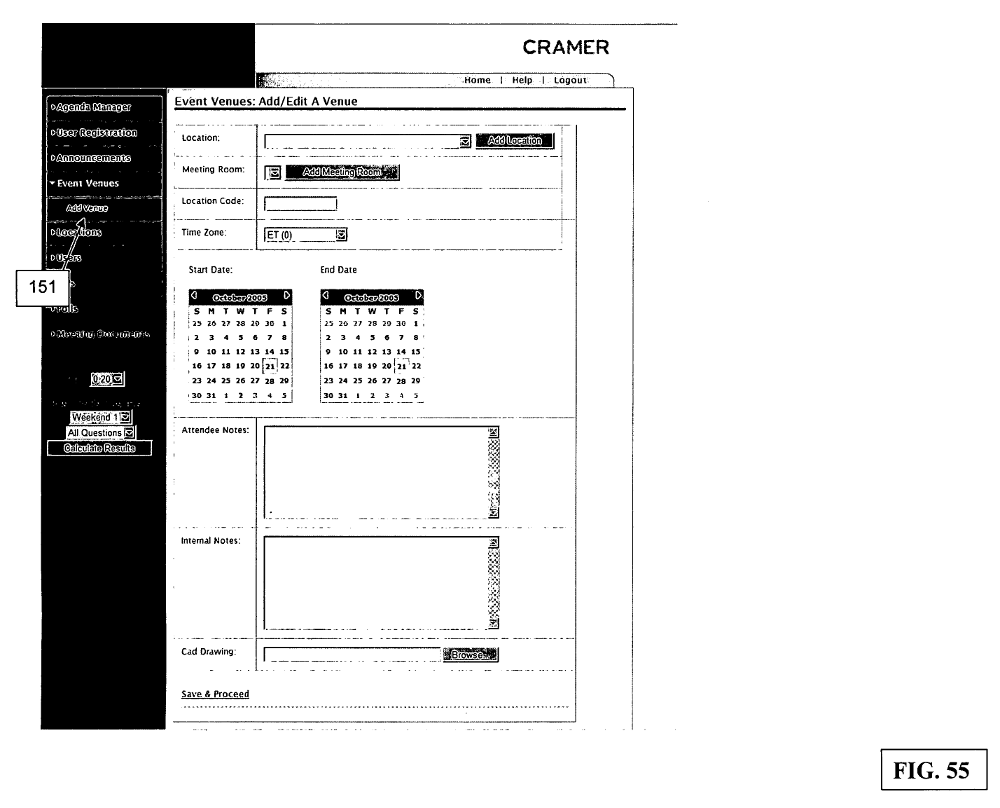

FIG. 52 details an embodiment of the event venues listing webpage. On this webpage the start date, end date, location, meeting room for event venues are displayed. Click on the edit button next to a listing leads the user to the webpage shown in FIG. 55. Clicking on the delete button will display a confirmation dialog asking for confirmation of the delete action, that when answered in the positive will cause the related records to be deleted from the database. Clicking on the +/−expander (147) in FIG. 53 will show additional venue information (148) such as address, contact information, directions and assigned staff as shown in FIG. 54.

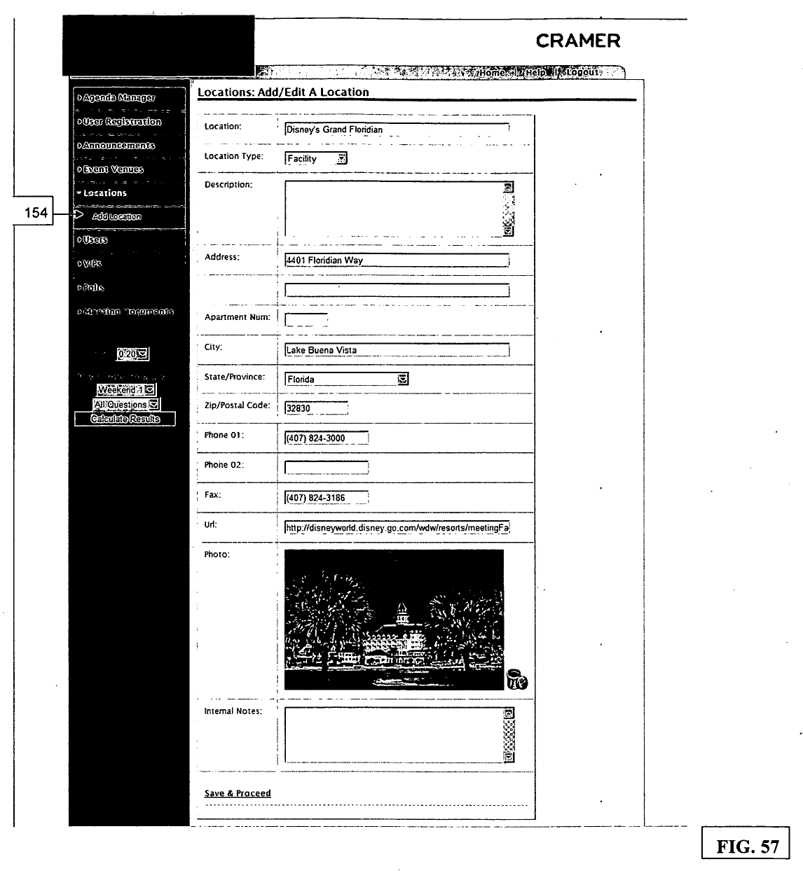

FIG. 55 details an embodiment of the add/edit event venue webpage. On this webpage the administrator can select a location from a pop-up list of venues or add a new location. Clicking on the “Add Location” link leads to the webpage shown in FIG. 57. On this add/edit webpage the user can further select a meeting room from a pop-up list of meeting rooms, add a new meeting room, enter a location code, select the time zone, select the start and end times and add attendee notes, internal notes as well as add a CAD drawing of the floor plan. Clicking on “Save and Proceed” stores the information in the database. Clicking on the Add Venue link (151) allows the user to add a new event venue.

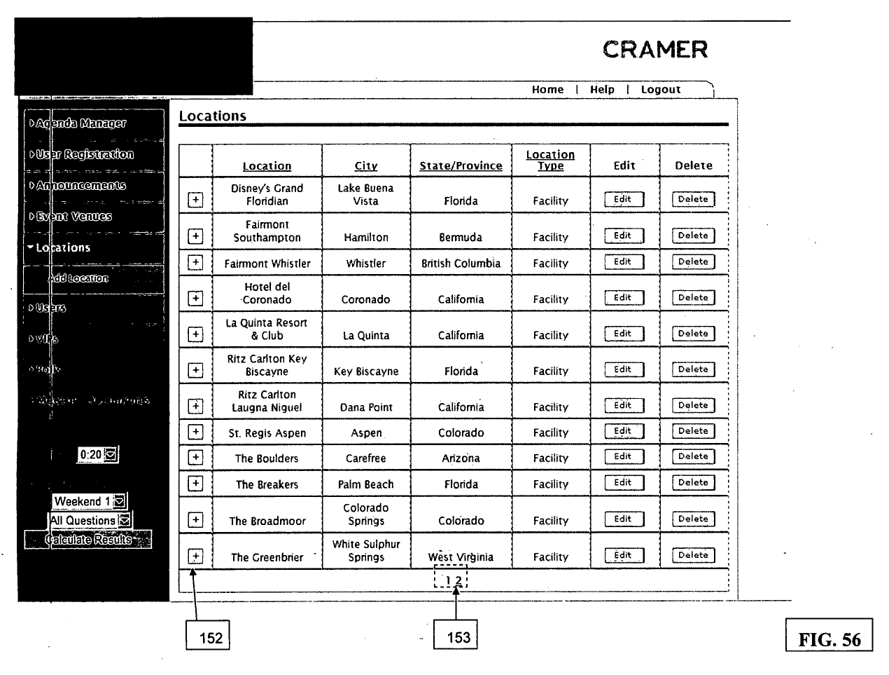

FIG. 56 details an embodiment of the location listing webpage. On this webpage the location, city, state and type of location are shown. The administrator may click links to edit and delete records. Clicking on the delete button will display a confirmation dialog asking for confirmation of the delete action, that when answered in the positive will cause the related records to be deleted from the database. Clicking on the edit button leads the administrator to the webpage show in FIG. 57. Clicking on the +/−expander (152) will show additional location information such as description, address, contact information and notes. Clicking on the page links (153) allows the administrator to see more locations.

FIG. 57 details an embodiment of the add/edit location webpage. On this webpage the administrator can enter the location name, select a location type from pop-up menu, enter a description, enter a address and secondary address, enter a city, select a state from a pop-up menu, enter a postal code, enter two phone numbers, enter a fax number, enter a URL, upload a photo and enter internal notes. Clicking on the “Save and Proceed” link will cause the entered data to be stored in the database. Clicking on the Add Location link (154) allows the administrator to add a new location.

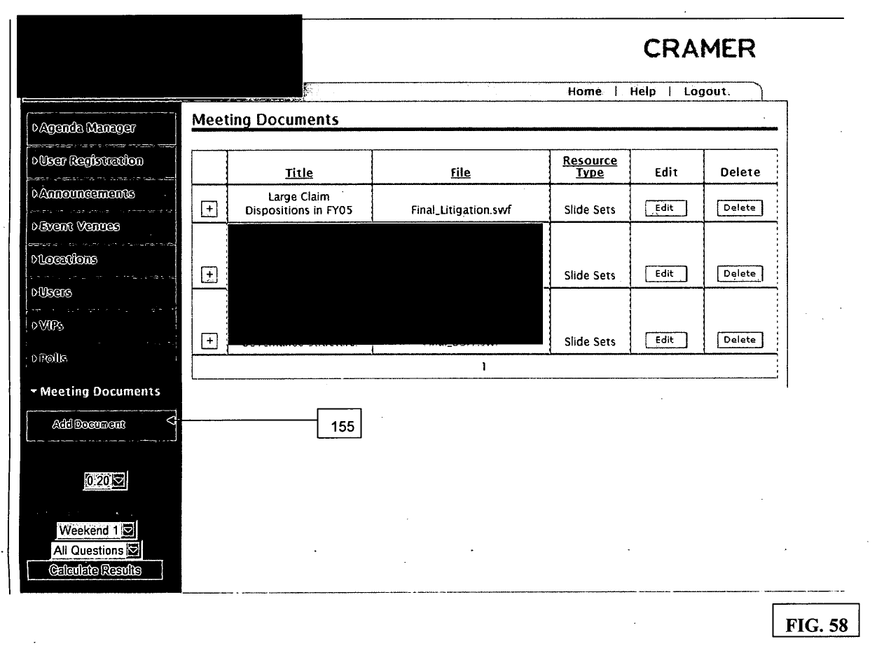

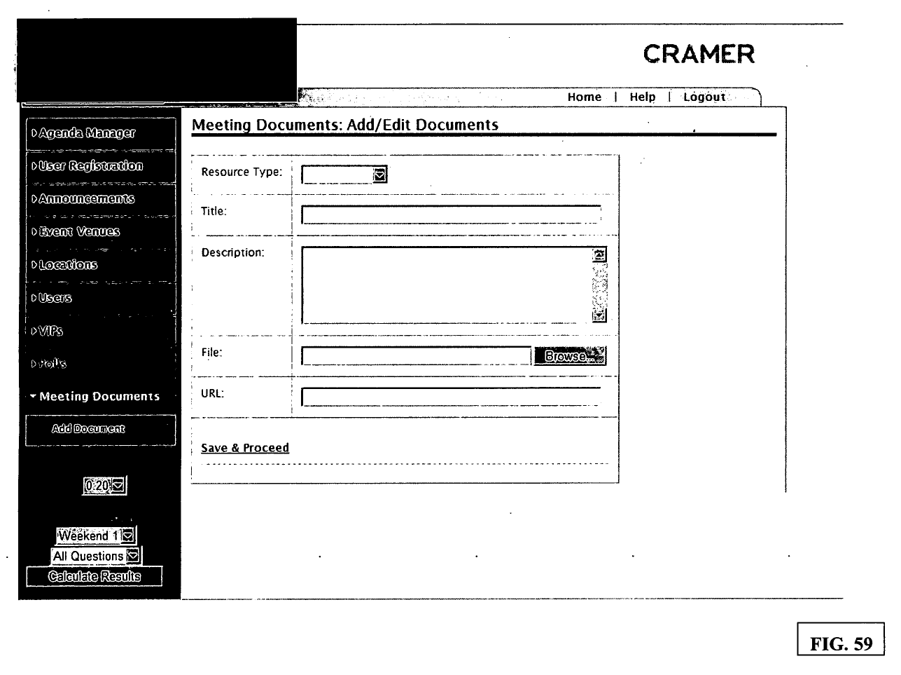

FIG. 58 details an embodiment of the meeting materials listing webpage. The title, file name and resource type are listed. The administrator may click links to edit and delete records. Clicking on the “Edit” button leads the administrator to the webpage shown in FIG. 59. Clicking on the delete button will display a confirmation dialog asking for confirmation of the delete action, that when answered in the positive will cause the related records to be deleted from the database. Clicking on the +/−expander will show additional information of description and URL. Clicking on the Add Document link (155) allows the administrator to add a new meeting material document.

FIG. 59 details an embodiment of the add/edit meeting material webpage. On this webpage the administrator can select a resource type from a pop-up menu, enter a title, enter a description, browse for an image file and enter a URL to define a meeting material item. Clicking on the save and proceed webpage with cause this information to be stored in the database.

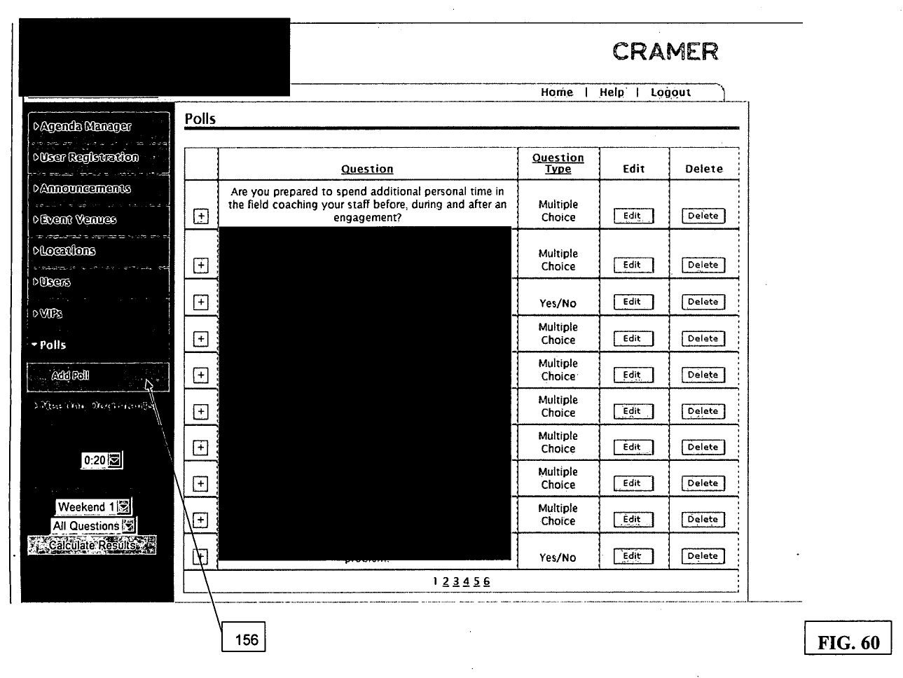

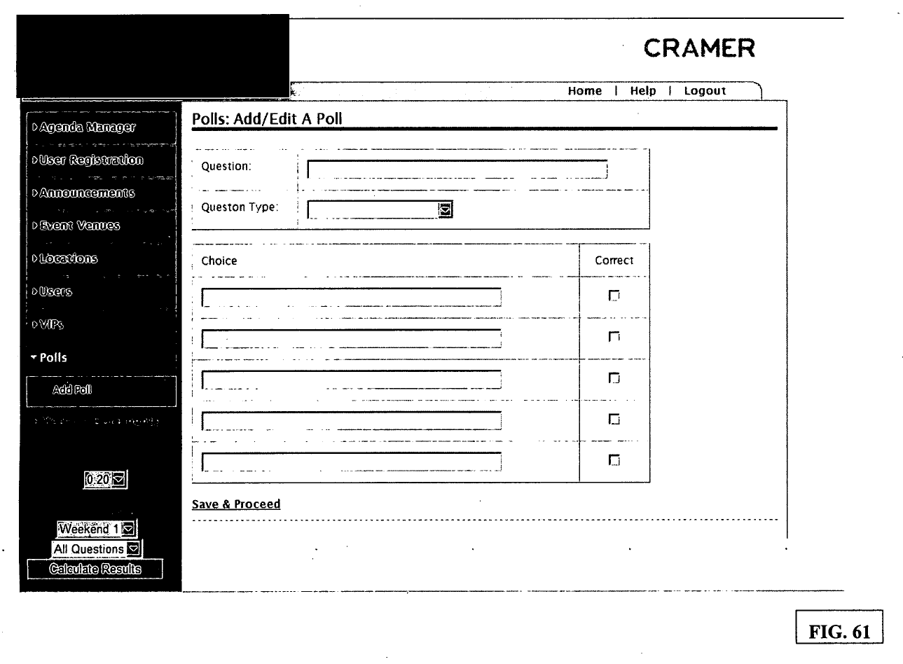

FIG. 60 details an embodiment of the poll listing webpage. The question and question type are shown. The administrator may click links to edit and delete records. Clicking on the “Edit” button leads the administrator to the webpage shown in FIG. 61. Clicking on the delete button will display a confirmation dialog asking for confirmation of the delete action, that when answered in the positive will cause the related records to be deleted from the database. Clicking on the +/−expander will show the additional information of answer choices if applicable. Clicking on the Add Poll link (156) allows the administrator to add a new poll item (FIG. 61).

FIG. 61 details an embodiment of the add/edit poll webpage. On this screen the administrator can enter a question, select the question type from a pop-up menu, enter one to five answer choices and optionally indicate which answer choices is/are correct. Clicking on the save and proceed webpage with cause this information to be stored in the database.

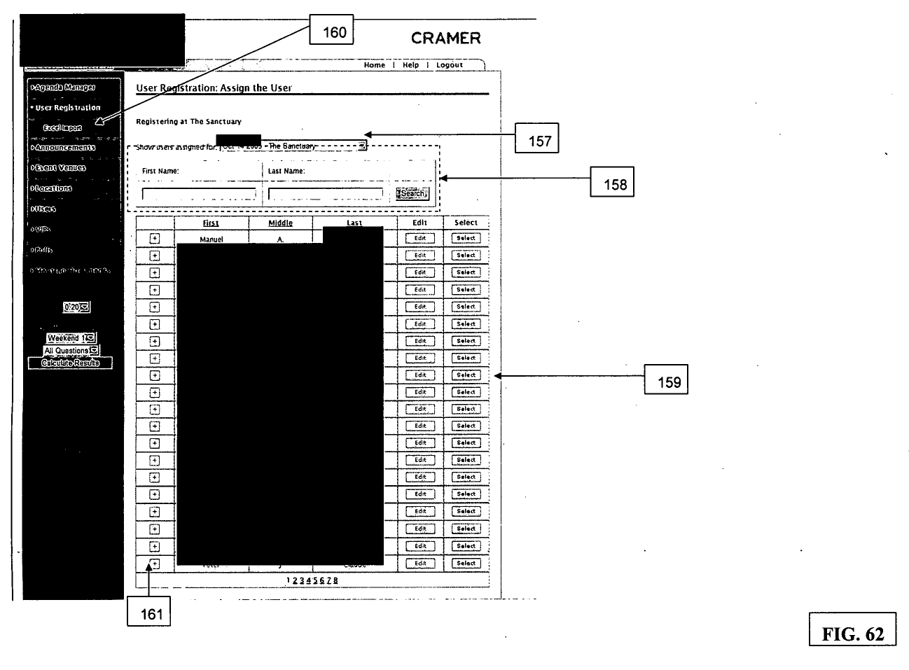

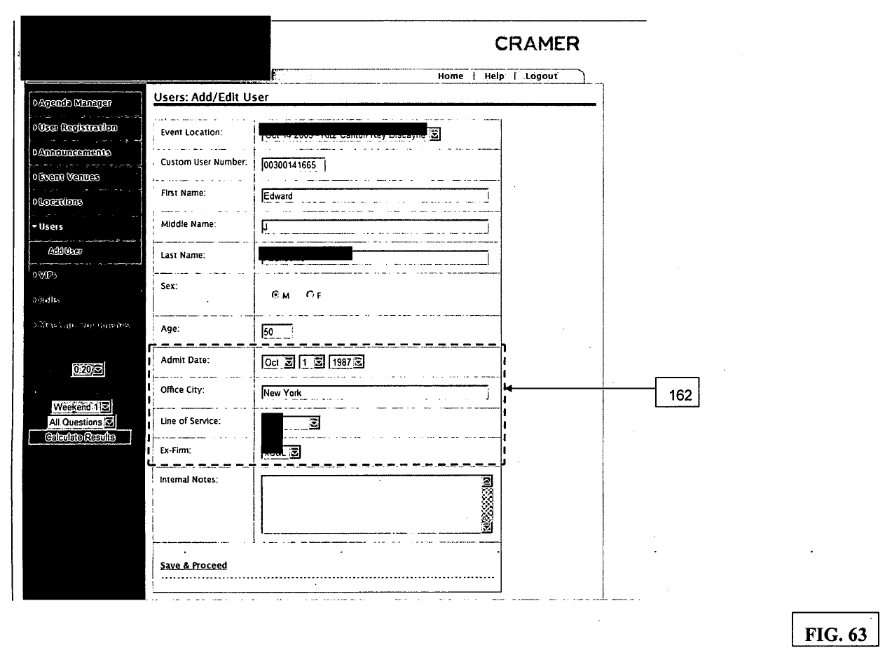

FIG. 62 details an embodiment of the assign user webpage. This webpage allows the administrator to assign individuals to a particular event. Using this webpage the administrator selects the event he wishes to assign users to from a pop-up menu (157). The administrator can then browse for users to assign by searching for them by first or last name (158). Search results are displayed in the area below (159). By default and on blank searches all available users are shown. The user listing area shows first, middle and last names. Buttons to edit a user record that link to the webpage shown in FIG. 63 as well as a select button to assign the individual are available for each record shown. Clicking on the +/−expander (161) will show additional information for the user such as internal notes and demographic information. The Excel Import link (160) will bring the administrator to a screen that will allow the administrator to browse for an Excel file to allow bulk importation of users.

FIG. 63 details an embodiment of the add/edit user webpage. On this webpage the administrator can select an event location from a pop-up menu, enter custom user number, enter first, middle and last names, select their sex from a group of radio buttons, enter the age and provide additional demographic information (162) as previously defined with the client, as well as internal notes for use by administrators. Clicking on the save and proceed webpage with cause this information to be stored in the database.

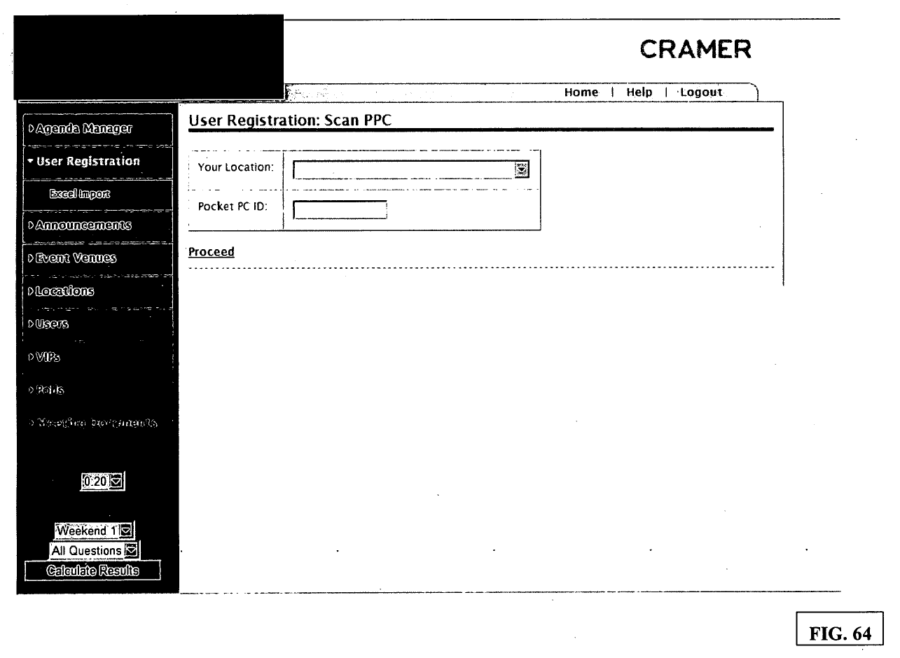

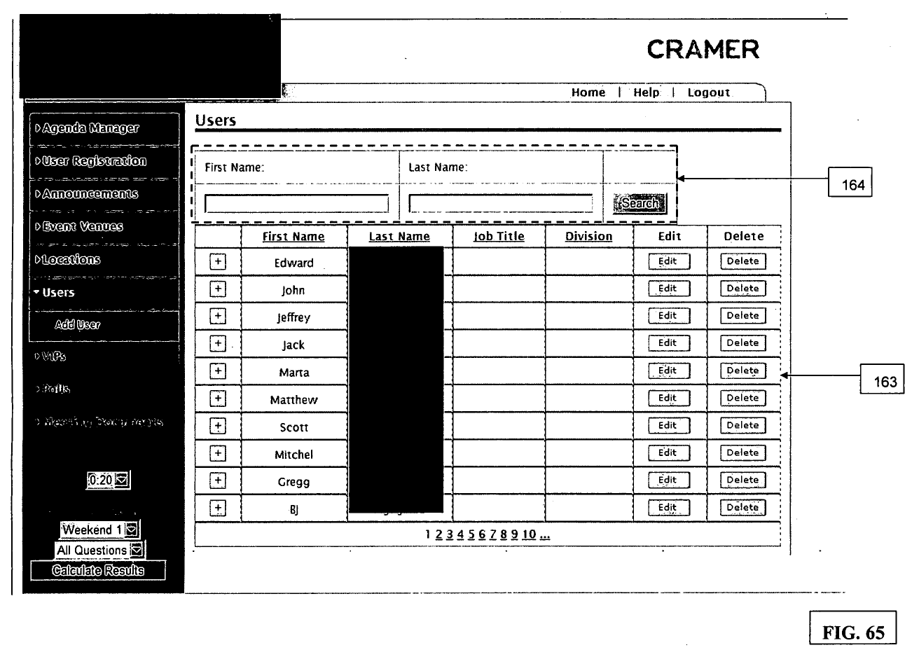

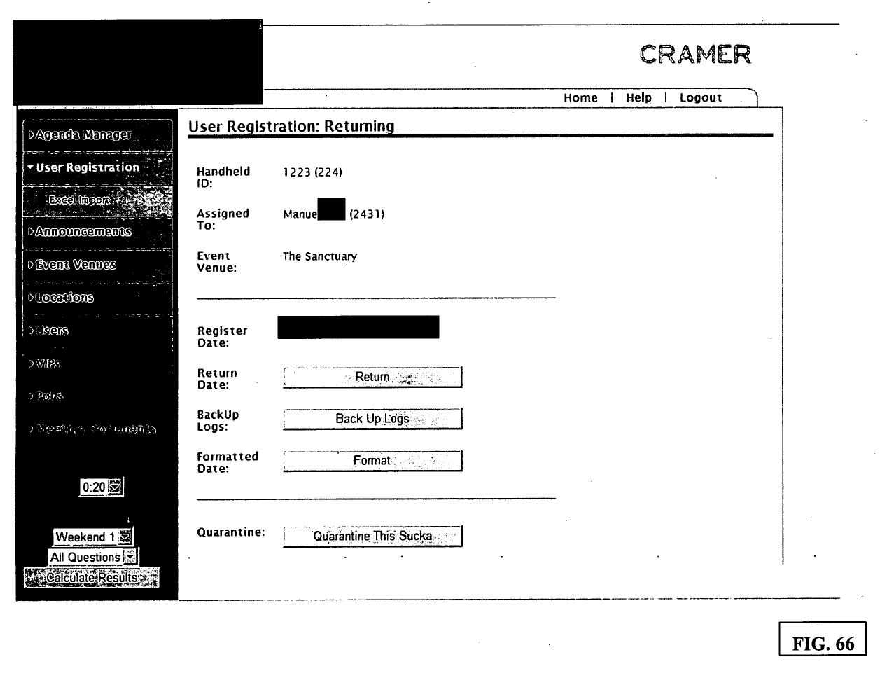

FIG. 64 details an embodiment of the add/edit user webpage. On this webpage the administrator can select an event location from a pop-up menu and enter a handheld device ID. If the device ID entered has not been assigned to a user previously the “Proceed” link brings the user to the screen shown in FIG. 65. If the device ID entered is assigned to an individual the “Proceed” link bring the user to the webpage shown in FIG. 66.

FIG. 65 details an embodiment of the assign user to device webpage. The administrator can browse for users (163) to assign by searching for them by first or last name (164). Search results are displayed in the browse area below (163). By default and on blank searches all available users are shown. The user listing area shows first, middle and last names. Buttons to edit a user record that link to the webpage shown in FIG. 63 as well as a select button to assign the individual user are available for each record shown. Clicking on the +/−expander will show additional information for the user such as internal notes and demographic information.

FIG. 66 details an embodiment of the assigned device webpage. The handheld ID, individual the device is assigned to, venue and registration date are displayed. The device return and backup date are shown if those processes have occurred. Device return and backup buttons are show to if those processes have not occurred. A quarantine button is available that will remove the user association from the selected device and mark the device as unavailable.

What is claimed is:

1. A method for managing an event comprising the steps of:
a) maintaining a primary user-interactive web page linked to a plurality of secondary user-interactive web pages, wherein the plurality of secondary user-interactive web pages includes means for allowing users to input specific event data, and wherein the plurality of secondary user-interactive webpages is further linked to a database in which all said specific event data is stored in defined categories;
b) setting up a first server at an event location;
c) distributing the entered event data into the first server;
d) connecting a first computer at the event location to the first server;
e) distributing the entered event data on the first server to the first computer;
f) using the first computer to control entered event data contained on the first server;
f) using a first wireless connection to connect the handheld event liaison device to the first server;
g) using the first computer to distribute the entered event data from the first server to the handheld event liaison devices;
h) registering the handheld event liaison device to a user at the event location;
wherein each handheld event liaison device comprises at least one display area;
at least one primary user interactive display page, wherein the primary user-interactive display page may be displayed on the display area; and an administrator interactive display page.

2. The method of claim 1, wherein the primary user-interactive display page of the handheld event liaison device further includes a primary navigation bar comprising one or more of the following indicators: a battery life indicator, a wireless network connection indicator, a current date indicator, a current time indicator.

3. The method of claim 1, wherein the handheld event liaison device comprises a plurality of secondary user interface display pages comprising one or more of the following pages: a home page, a primary agenda page, a primary poll results page, a primary speakers page, a primary inbox page, a primary meeting materials page, a primary concierge page, a primary ask a question page and a primary settings page.

4. The method of claim 1, wherein the primary user-interactive display page comprises a plurality of buttons linked to the secondary user interface display pages comprising one or more of the following buttons: a first home page button linked to the home page, a first agenda page button linked to the primary agenda page, a first poll results button linked to the primary poll results page, a first speakers button linked to the primary speakers page, a first inbox button linked to the primary inbox page, a first meeting materials button linked to the primary meeting materials page, a first concierge button linked to the primary concierge page, a first ask a question button linked to the primary ask a question page and a first settings button linked to the primary settings page wherein a user selection of any one of the above buttons will direct the handheld event liaison device to the corresponding linked secondary user-interface page.

5. The method of claim 4, wherein the first inbox button further comprises a number of messages indicator.

6. The method of claim 1, wherein the primary user-interactive display page comprises a first agenda summary display comprising one or more of the following indicators: a first agenda start time indicator, a first agenda end time indicator, a first agenda date indicator, a first agenda text indicator, and a first agenda location indicator.

7. The method of claim 6, wherein the first agenda summary display further comprises a second agenda page button linked to the primary agenda page.

8. The method of claim 3, wherein the primary agenda page comprises a plurality of agenda displays.

9. The method of claim 8, wherein each agenda display comprises a button linked to a secondary agenda details page.

10. The method of claim 9, wherein the secondary agenda detail page comprises one or more of the following agenda items: an agenda start time display, an agenda end time display, an agenda date display, agenda text display, agenda location display, a second speakers button linked to the primary speakers page, a second meeting materials button linked to the primary meeting materials page, a second poll results button linked to the primary poll results page and a means for closing the secondary agenda details page;
wherein a user selection of any one of the above buttons will direct the handheld event liaison device to the corresponding linked secondary user-interface page.

11. The method of claim 3, wherein the primary agenda page comprises a first agenda display.

12. The method of claim 11, wherein the first agenda display is highlighted.

13. The method of claim 11, wherein the primary agenda page comprises at least one second agenda display.

14. The method of claim 13, wherein the first agenda display and the second agenda display are listed chronologically by agenda start time.

15. The method of claim 3, wherein the primary speakers page comprises a plurality of user interface speaker name display buttons, wherein each individual speaker name display button is linked to a secondary speaker details page;
and further wherein the speaker details page comprises speaker information, and a means for closing said speaker details page.

16. The method of claim 3, wherein the primary inbox page comprises at least one message item, wherein said message item further comprises a message details button linked to a message details page, an importance level indicator, a subject indicator, a receipt date indicator and a receipt time indicator.

17. The method of claim 16, wherein the message items are ordered chronologically by receipt date and receipt time.

18. The method of claim 16, wherein the message details page comprises header information, and message data, and a means for closing said message details page.

19. The method of claim 3, wherein the primary meeting materials page comprises a plurality of user interface meeting material display buttons, wherein each individual meeting material display button is linked to a secondary meeting materials details page.

20. The method of claim 3, wherein the primary concierge page comprises a plurality of amenity displays.

21. The method of claim 20, wherein each amenity display comprises a button linked to a secondary amenity details page.

22. The method of claim 3, wherein the primary setting page includes a button linked to a programmed guided tour and a button linked to a user interface screen orientation page.

23. The method of claim 3, wherein the primary poll results page comprises a plurality of poll result items including a category, a poll question, and a poll results button linked to a poll results details page.

24. The method of claim 3, where in the primary ask a question page includes means for the user to input a question.

25. The method of claim 1, wherein the handheld event liaison device further comprises means for message notification, wherein the message notification includes a notification priority.

26. The method of claim 1, wherein the handheld event liaison device further comprises means for poll notification.

27. The method of claim 5, wherein the means for poll notification comprises a poll question, means for providing a poll answer on the poll results page, means for providing an error message, and means for providing a confirmation screen.

28. The method of claim 1, wherein the website contains a microsite.

29. The method of claim 1, wherein the event data is selected from the group consisting of: event location information, reservation requirements, schedule and description of presentations, speaker biographies, meeting materials, event agendas, poll questions, and event location amenity information.

30. The method of claim 1, wherein the first server is connected to the first computer by a wired connection or a second wireless connection.

31. The method of claim 1, further comprising the steps of:
a) using the first computer to distribute a poll to the first server;
b) using the first server to distribute the poll to the handheld event liaison device;
c) having the user input a poll answer into the handheld event liaison device;
d) using the handheld event liaison device to distribute the poll answer to the first server;
e) analyzing the poll results; and
f) distributing the poll results from the first server to the handheld event liaison device.

32. The method of claim 31, wherein the poll comprises one or more questions.

33. The method of claim 1, wherein the first server hosts a number of software applications selected from database applications, web server applications and synchronization applications.

34. The method of claim 1, further comprising a second computer used to present results to an audience via projection or television broadcast which is connected to the first server.
